(19) United States
(12) Patent Application Publication
(10) Pub. No.: US 2025/0227800 A1
(43) Pub. Date: Jul. 10, 2025

(54) Information Sharing Between Radio Access Networks (RANs) for a User Equipment (UE) Configured with Dual Stack Dual Connectivity

(71) Applicant: QUALCOMM Incorporated, San Diego, CA (US)

(72) Inventors: Punyaslok PURKAYASTHA, San Diego, CA (US); Gavin Bernard HORN, La Jolla, CA (US); Ozcan OZTURK, San Diego, CA (US); Miguel GRIOT, La Jolla, CA (US)

(21) Appl. No.: 18/405,869

(22) Filed: Jan. 5, 2024

(51) Int. Cl. H04W 76/27; H04W 72/54; H04W 88/06

(52) U.S. Cl. CPC H04W 76/27; H04W 72/54; H04W 88/06

(57) ABSTRACT

Certain aspects of the present disclosure provide techniques for information sharing between radio access networks (RANs). A method generally includes communicating between a first network entity (associated with a first radio access network (RAN)) and a second network entity (associated with a second RAN) and/or a user equipment (UE): one or more first parameters based on measurements for a first user plane configured for exchanging information between the UE and the first network entity; one or more second parameters based on measurements for a second user plane configured for exchanging information between the UE and the second network entity; a first radio resource control (RRC) state of the UE in the first RAN; and/or a second RRC state of the UE in the second RAN; and operate based on the one or more first parameters, the one or more second parameters, the first RRC state, or the second RRC state.

### INTRODUCTION

### Field of the Disclosure

Aspects of the present disclosure relate to wireless communications, and more particularly, to techniques for information sharing between radio access networks (RANs).

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communications by an apparatus. The method includes communicating between the apparatus and at least one of a first network entity or a user equipment (UE), at least one of: one or more first parameters based on measurements for a first user plane configured for exchanging information between the UE and the first network entity, wherein the first network entity is associated with a first radio access network (RAN); one or more second parameters based on measurements for a second user plane configured for exchanging information between the UE and the apparatus, wherein the apparatus is associated with a second RAN; a first radio resource control (RRC) state of the UE in the first RAN: or a second RRC state of the UE in the second RAN; and operating based on at least one of the one or more first parameters, the one or more second parameters, the first RRC state of the UE in the first RAN, or the second RRC state of the UE in the second RAN.

Another aspect provides a method for wireless communications by an apparatus. The method includes communicating between the apparatus and at least one of a first network entity or a second network entity, at least one of: one or more first parameters based on measurements for a first user plane configured for exchanging information between the apparatus and the first network entity, wherein the first network entity is associated with a first RAN; one or more second parameters based on measurements for a second user plane configured for exchanging information between the apparatus and the second network entity, wherein the second network entity is associated with a second RAN: a first RRC state of the apparatus in the first RAN; or a second RRC state of the apparatus in the second RAN; and operating based on at least one of the one or more first parameters, the one or more second parameters, the first RRC state of the apparatus in the first RAN, or the second RRC state of the apparatus in the second RAN.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment (UE).

FIGS. 4A, 4B, 4C, and 4D depict various example aspects of data structures for a wireless communications network.

FIG. 5 depicts example dual connectivity for a UE.

FIGS. 6A, 6B, and 6C depict process flows for communications between a first network entity associated with a first radio access network (RAN), a second network entity associated with a second RAN, and a UE.

FIG. 7 depicts a method for wireless communications.

FIG. 8 depicts another method for wireless communications.

FIG. 9 depicts aspects of an example communications device.

FIG. 10 depicts aspects of an example communications device.

### DETAILED DESCRIPTION

Aspects of the present disclosure provide apparatuses, methods, processing systems, and computer-readable mediums for sharing information between network entities associated with different radio access networks (RANs). Specifically, information may be shared between a first network entity, associated with a first RAN (e.g., implementing a first radio access technology (RAT), such as 5G), and a second network entity, associated with a second RAN (e.g., implementing a second RAT, such as 6G). The first network entity and the second network entity may each have previously established a radio resource control (RRC) connection with a same user equipment (UE). Specifically, the UE may be a dual stack, dual connectivity configured device capable of connecting to two network entities simultaneously for the transmission and/or reception of data. Further, the dual stack design of the UE enables the connection to be to two network entities of different RANs.

Dual connectivity is a solution in wireless communications systems that enables a UE to consume radio resources of two network entities (e.g., operating same or different RATs) in order to enhance user experience and network efficiency. For example, dual connectivity allows a UE to be connected simultaneously to two different cell groups associated with two different network entities, such as a first network entity and a second network entity. An increase in overall throughput, and accordingly data rates for the UE, may be achieved by aggregating radio resources from at least the two network entities. Further, mobility robustness may be achieved by being simultaneously connected to the different cell groups. For example, uninterrupted communication and/or smooth handovers may be realized, even in cases where the UE is moving at high speeds. Dual connectivity may also help in load balancing by enabling the offloading of traffic between cell groups/network entities to distribute the traffic load of the UE and/or help prevent congestion in the RAN associated with the first network entity and/or the second network entity. Moreover, dual connectivity may allow the UE to leverage the capabilities of different networks in cases where the first network entity is associated with a first RAN and the second network entity is associated with a second RAN. This may help to ensure interoperability of the networks without disrupting existing services.

To help realize such benefits in dual connectivity implementations, it may be beneficial for the first network entity (and/or UE) to share information about (1) the UE and/or (2) a first user plane used for the exchange of information between the first network entity and the UE, with the second network entity. Further, it may be beneficial for the second network entity (and/or UE) to share information about (1) the UE and/or (2) a second user plane used for the exchange of information between the second network entity and the UE, with the first network entity. For example, uplink and/or downlink throughput information associated with the first user plane and communicated to the second network entity may allow the second network entity to make a more informed decision about whether load balancing between the first network entity and the second network entity may be useful for the UE.

Accordingly, aspects described herein provide techniques for sharing information between two network entities associated with different RANs and connected to a same dual stack, dual connectivity configured UE. While aspects herein are described with respect to dual connectivity implementations including a UE, a first network entity, and a second network entity, aspects of the present disclosure may likewise be applicable to multi-connectivity designs where a UE is connected to more than two network entities.

In some aspects, the information shared between the two network entities includes user plane parameter(s). The user plane parameter(s) may be based on (1) measurement(s) for the first user plane configured for exchanging information between the UE and the first network entity and/or (2) measurement(s) for the second user plane configured for exchanging information between the UE and the second network entity. The user plane parameter(s) may include information about uplink throughput, downlink throughput, uplink packet delay, downlink packet delay, packet loss rate, uplink capacity, downlink capacity, and/or the like. In some aspects, the user plane parameter(s) may be value(s) for one or more data radio bearers (DRBs) (e.g., used to transport user plane application data) associated with the first user plane and/or the second user plane. In some aspects, the user plane parameter(s) may be statistic(s) associated with two or more DRBs associated with the first user plane and/or the second user plane.

In some aspects, the information shared between the two network entities includes RRC state information for the UE. For example, a first RRC state (or mode) of the UE in the first RAN, associated with the first network entity, may be communicated to the second network entity. Further, a second RRC state (or mode) of the UE in the second RAN, associated with the second network entity, may be communicated to the first network entity. An RRC state of the UE in the first RAN or the second RAN may be (1) a connected state (also referred to as a “connected mode,” “RRC connected mode,” and/or “RRC connected state”), (2) an inactive state (also referred to as an “inactive mode,” “RRC inactive mode,” and/or “RRC inactive state”), or (3) an idle state (also referred to as an “idle mode,” “RRC idle mode,” and/or “RRC idle state”). The UE may be operating in a connected state in the first RAN or the second RAN after establishing an RRC connection with the first network entity in the first RAN or the second network entity in the second RAN, respectively. The UE may be operating in an idle state in the first RAN or the second RAN when the UE is not connected, or in other words, does not have an established RRC connection with the first network entity in the first RAN or the second network entity in the second RAN, respectively. The UE may be operating in an inactive state in the first RAN when the UE has an established RRC connection with first network entity in the first RAN, but the connection is in a dormant, suspended, or inactive state and there is no active communication between the UE and the first network entity. Further, the UE may be operating in an inactive state in the second RAN when the UE has an established RRC connection with second network entity in the second RAN, but the connection is in a dormant, suspended, or inactive state and there is no active communication between the UE and the second network entity. For example, while operating in the inactive state, unlike the idle state, a non-access stratum (NAS) layer of an RRC connection established by the UE may continue to be connected.

In some aspects, the user plane parameter(s) and/or the RRC state information for the UE may be communicated to the first network entity and/or the second network entity via a core network (CN) of the first RAN associated with the first network entity and a CN of the second RAN associated with the second network entity. In some aspects, the user plane parameter(s) and/or the RRC state information for the UE may be communicated to the first network entity and/or the second network entity via the UE. For example, the first network entity may determine the user plane parameter(s) and/or the RRC state information for the UE in the first RAN and communicate this information to the UE, which then communicates this information to the second network entity. Similarly, the second network entity may determine the user plane parameter(s) and/or the RRC state information for the UE in the second RAN and communicate this information to the UE, which then communicates this information to the first network entity. In some aspects, the user plane parameter(s) and/or the RRC state information for the UE may be determined by the UE and communicated to the first network entity and/or the second network entity by the UE itself. In comes cases, sharing of information between RANs, via the UE may result in faster communication speeds than when the information is shared via the CNs, due to the avoidance of delays associated with needing to share information between several nodes in each CN.

After receiving the user plane parameter(s) and/or the RRC state information, the first network entity and/or the second network entity may operate based on this information. Operating based on the received user plane parameter(s) and/or the RRC state information may include, for example, offloading a subset of traffic associated with DRB(s) on one user plane to the other user plane, activating packet duplication, and/or deactivating packet duplication, to name a few.

### Introduction to Wireless Communications Networks

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

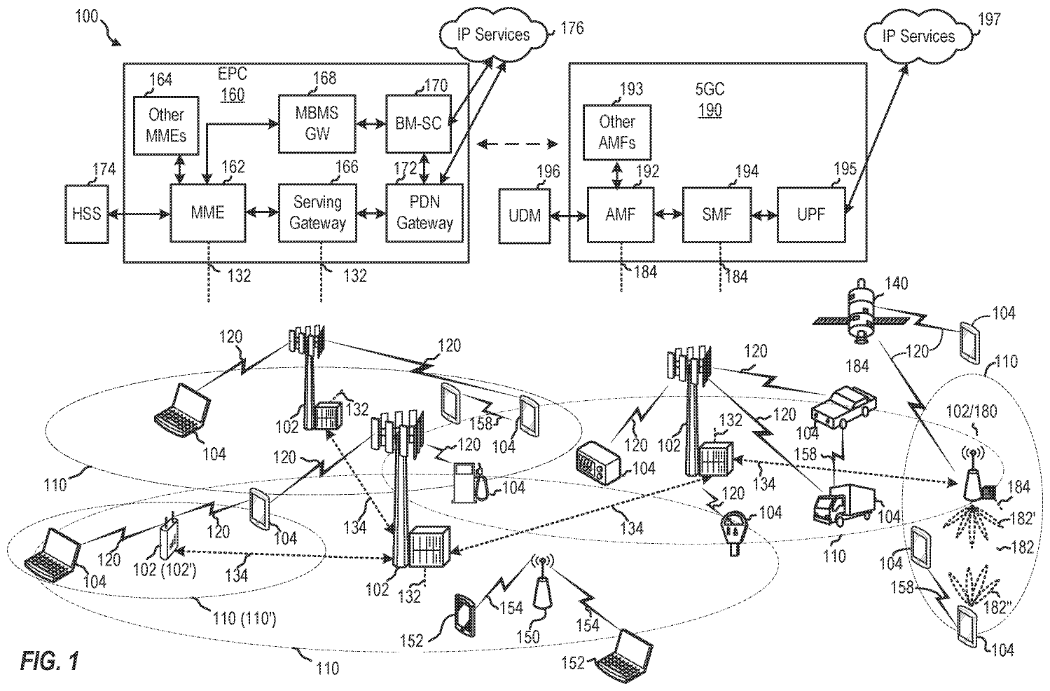

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 includes terrestrial aspects, such as ground-based network entities (e.g., BSs 102), and non-terrestrial aspects (also referred to herein as non-terrestrial network entities), such as satellite 140 and transporter, which may include network entities on-board (e.g., one or more BSs) capable of communicating with other network elements (e.g., terrestrial BSs) and UEs.

In the depicted example, wireless communications network 100 includes BSs 102. UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, data centers, or other similar devices. UEs 104 may also be referred to more generally as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

Generally, a cell may refer to a portion, partition, or segment of wireless communication coverage served by a network entity within a wireless communication network. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

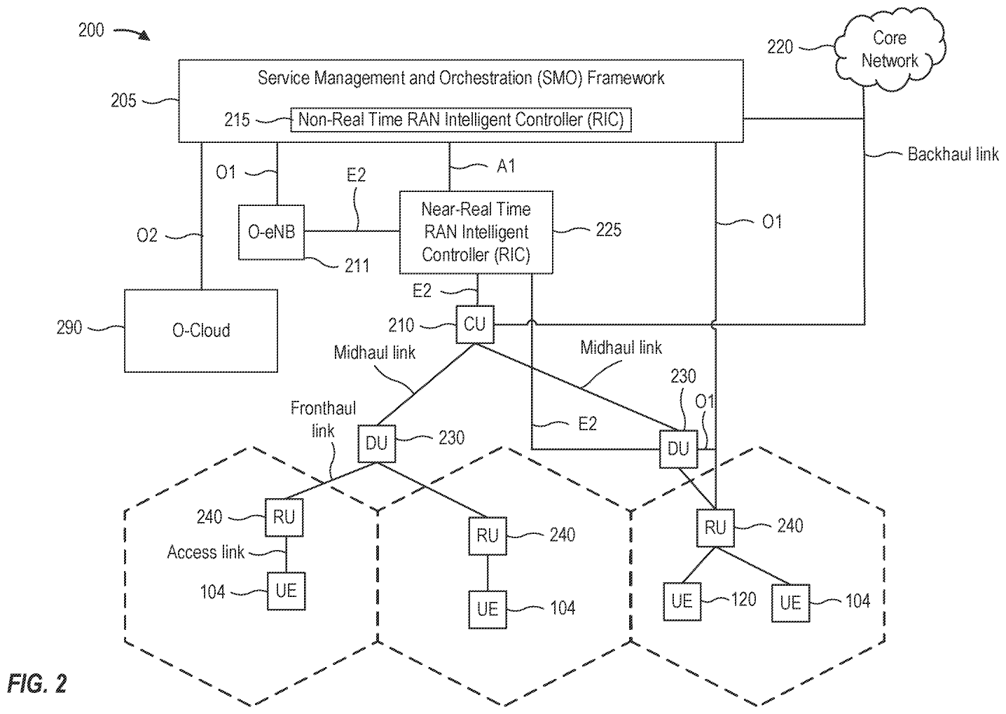

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUS), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, 5G, and/or 6G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an SI interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHZ-7125 MHz, which is often referred to (interchangeably) as “Sub-6 GHZ”. Similarly, 3GPP currently defines Frequency Range 2 (FR2) as including 24,250 MHZ-71,000 MHZ, which is sometimes referred to (interchangeably) as a “millimeter wave” (“mmW” or “mm Wave”). In some cases, FR2 may be further defined in terms of sub-ranges, such as a first sub-range FR2-1 including 24,250 MHZ-52,600 MHZ and a second sub-range FR2-2 including 52,600 MHZ-71,000 MHZ. A base station configured to communicate using mm Wave/near mm Wave radio frequency bands (e.g., a mm Wave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHZ and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QOS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUS 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via 01) or via creation of RAN management policies (such as A1 policies).

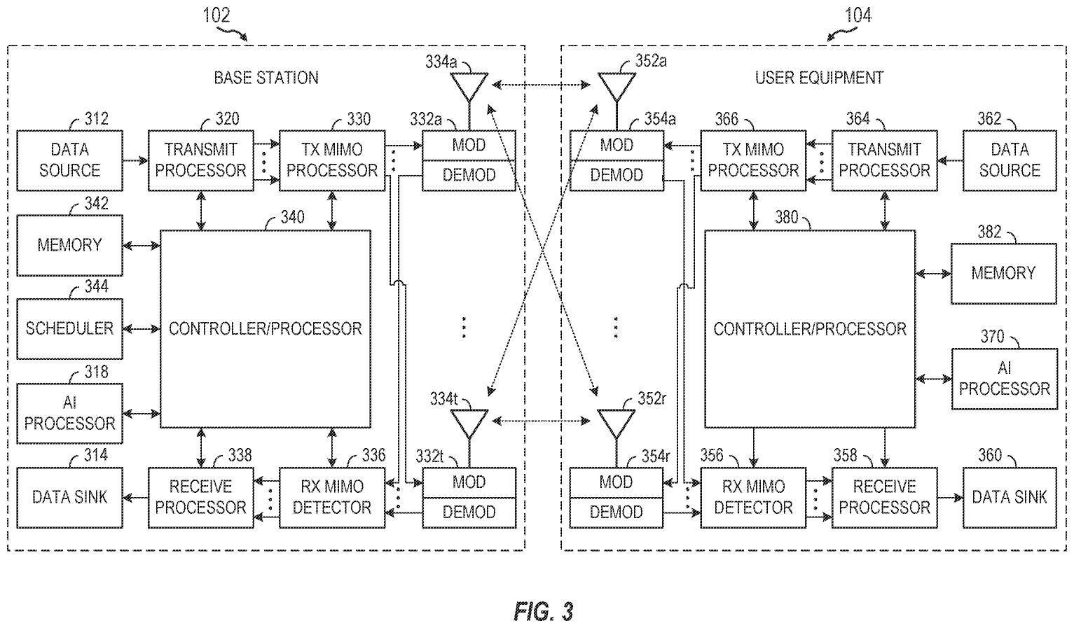

FIG. 3 depicts aspects of an example BS 102 and a UE 104.

Generally, BS 102 includes various processors (e.g., 318, 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 314). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, 370, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

RX MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a RX MIMO detector 336 if applicable, and further processed by a receive processor 338 to obtain decoded data and control information sent by UE 104. Receive processor 338 may provide the decoded data to a data sink 314 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

In various aspects, artificial intelligence (AI) processors 318 and 370 may perform AI processing for BS 102 and/or UE 104, respectively. The AI processor 318 may include AI accelerator hardware or circuitry such as one or more neural processing units (NPUs), one or more neural network processors, one or more tensor processors, one or more deep learning processors, etc. The AI processor 370 may likewise include AI accelerator hardware or circuitry. As an example, the AI processor 370 may perform AI-based beam management, AI-based channel state feedback (CSF), AI-based antenna tuning, and/or AI-based positioning (e.g., global navigation satellite system (GNSS) positioning). In some cases, the AI processor 318 may process feedback from the UE 104 (e.g., CSF) using hardware accelerated AI inferences and/or AI training. The AI processor 318 may decode compressed CSF from the UE 104, for example, using a hardware accelerated AI inference associated with the CSF. In certain cases, the AI processor 318 may perform certain RAN-based functions including, for example, network planning, network performance management, energy-efficient network operations, etc.

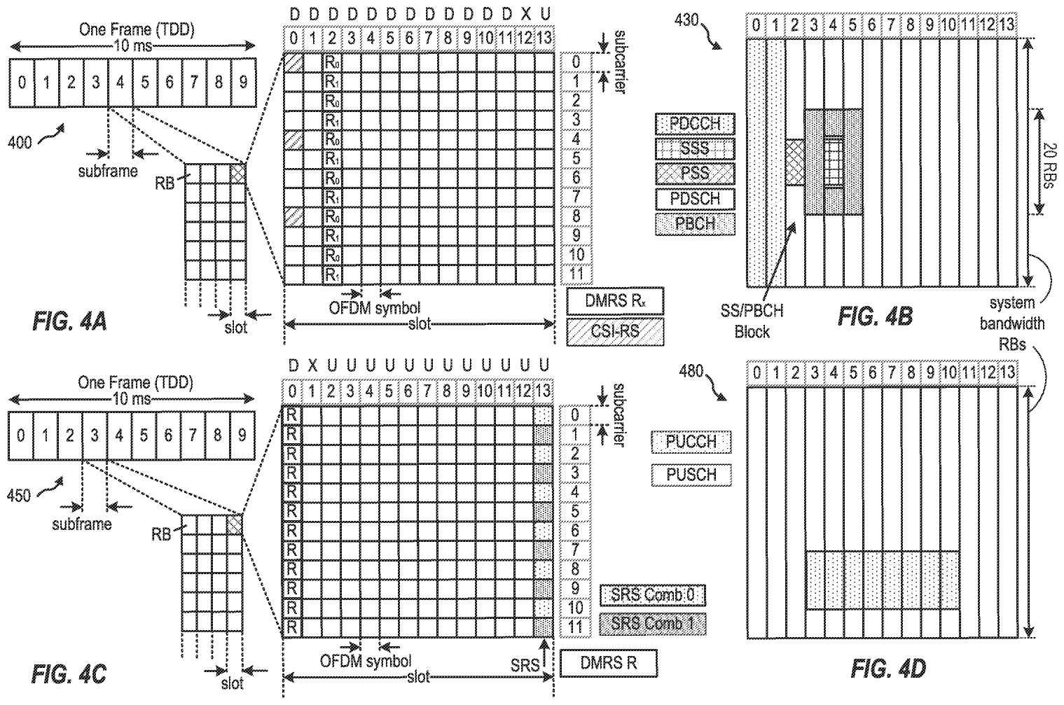

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL. U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology, which may define a frequency domain subcarrier spacing and symbol duration as further described herein. In certain aspects, given a numerology μ, there are 2^{μ} slots per subframe. Thus, numerologies (μ) 0 to 6 may allow for 1, 2, 4, 8, 16, 32, and 64 slots, respectively, per subframe. In some cases, the extended CP (e.g., 12 symbols per slot) may be used with a specific numerology, e.g., numerology 2 allowing for 4 slots per subframe. The subcarrier spacing and symbol length/duration are a function of the numerology. The subcarrier spacing may be equal to 2^{μ}×15 kHz, where μ is the numerology 0 to 6. As an example, the numerology μ=0 corresponds to a subcarrier spacing of 15 kHz, and the numerology μ=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 KHz. and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Aspects Related to UE Dual Connectivity

Dual connectivity refers to the concurrent use of two independent communication paths and network entities (e.g., BSs such as BS 102 depicted and described with respect to FIGS. 1 and 3 or a disaggregated base station depicted and described with respect to FIG. 2) for data transmission to/from a UE. For example, where a UE is configured with dual connectivity, the UE may simultaneously transmit and receive data on different cell groups associated with two different network entities. In some cases, the network entities are associated with a same RAN implementing same radio access technology (RAT) (e.g., 3G, 4G, 5G, and/or 6G). In some other cases, the network entities are associated with different RANs implementing different RATs.

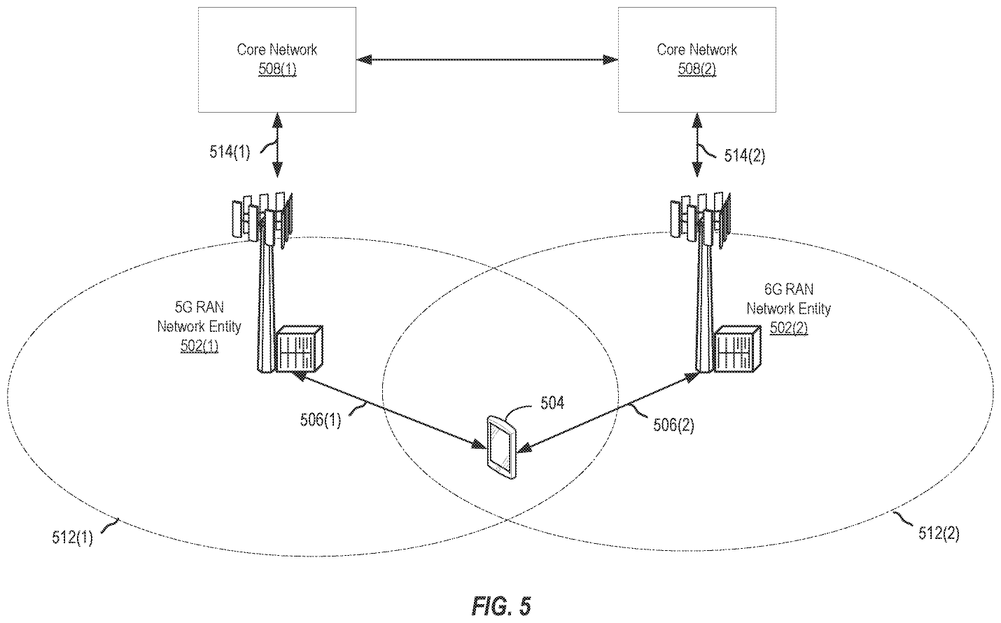

FIG. 5 depicts example dual connectivity. As shown, UE 504 (e.g., such as UE 104 of FIGS. 1 and 3 configured to dual connectivity) may establish a first RRC connection and a first communication link 506(1) a with a first network entity 502(1) (e.g., via a Uu interface). First network entity 502(1) is associated with a first RAN and is configured to support a first RAT, for example, 5G RAT. Additionally, UE 504 may establish a second RRC connection and a second communication link 506(2) with a second network entity 502(2) a (e.g., via a Uu interface). Second network entity 502(2) is associated with a second RAN and is configured to support a second RAT, for example, 6G RAT. UE 504 may establish both first communication link 506(1) and second communication link 506(2) when UE 504 is located within a coverage area (e.g., cell 512(1) and cell 512(2)) served by both first network entity 502(1) and second network entity 502(2).

In some aspects, first network entity 502(1) communicates with second network entity 502(2) via core network 508(1) (e.g., a 5G core network) and core network 508(2) (e.g., a 6G core network). Specifically, first network entity 502(1) may establish a first backhaul link 514(1) with core network 508(1) to communicate data between first network entity 502(1) and core network 508(1). Additionally, second network entity 502(2) may establish a second backhaul link 514(2) with core network 508(2) to communicate data between second network entity 502(2) and core network 508(2). Communication between core network 508(1) and core network 508(2) may also be established to communicate data between first network entity 502(1) and second network entity 502(2). For example, capability information of UE 504 may be shared between first network entity 502(1) and second network entity 502(2) via core network 508(1) and core network 508(2).

After establishing an RRC connection with first network entity 502(1) and second network entity 502(2), UE 504 may be operating in a connected state (also referred to as a “connected mode.” “RRC connected mode,” and/or “RRC connected state”) with first network entity 502(1) and second network entity 502(2). At some later time, an RRC state (or mode) of UE 504 may change from the connected state to an idle state or an inactive state. State information of the RRC connection for the UE is maintained at the UE and the first network entity 502(1) and/or second network entity 502(2),

Dual connectivity designs, such as the dual connectivity of UE 504 illustrated in FIG. 5, provides many benefits, including but not limited to, load balancing between network entities (e.g., first network entity 502(1) and second network entity 502(2) in FIG. 5), enhanced network coverage, and improved data rates.

For example, dual connectivity may allow for the use of radio resources from two cells, resulting in higher data rates for UE 504. The combined capacity of the cells increases the overall throughput and enables faster download and upload speeds at UE 504. This may be particularly advantageous in areas with high user density and/or limited coverage. This may also help to improve data speeds, especially for applications that require a lot of bandwidth, such as streaming video and/or gaming applications.

Dual connectivity may also allow for load balancing between cells to optimize resource allocation and improve network efficiency. For example, first network entity 502(1) connected to UE 504 may offload traffic to the cells associated with the second network entity (of the two network entities), thereby distributing the load and preventing congestion in the network. This helps to ensure efficient utilization of available resources and/or improve overall network performance.

Dual connectivity may also help to improve network coverage by establishing connections with two cells (e.g., one cell associated with first network entity 502(1) and the one cell associated with second network entity 502(2)). This helps to create a more reliable connection for UE 504, as well as helps to reduce the likelihood of signal loss and/or degradation in challenging environments. For example, 5G and 6G wireless communication coverage may be available within a same geographic coverage area, and having UE 504 connect to both the 5G network and 6G network in this area (e.g., shown in FIG. 5) may provide for more reliable connection. For instance, if the 5G wireless connection becomes poor, UE 504 may drop its connection with first network entity 502(1) (e.g., configured to support 5G RAT) and still maintain a connection with second network entity 502(2) (e.g., configured to support 6G RAT) for data transmission and reception.

To help realize such benefits of dual connectivity implementations, it may be beneficial to share information between first network entity 502(1) (e.g., associated with a 5G RAN and configured to support 5G RAT) and second network entity 502(2) (e.g., associated with a 6G RAN and configured to support 6G RAT). This information may be information beyond UE capability information shared between first network entity 502(1) and second network entity 502(2), via core network 508(1) and core network 508(2), as described above.

Aspects Related to Information Sharing Between RANs for a UE Configured with Dual Stack, Dual Connectivity

Aspects described herein provide techniques for exchanging information between two network entities associated with different RANs. The two network entities may have previously established an RRC connection with a same UE configured with dual stack, dual connectivity, and the UE may be operating in a connected, idle, or inactive state with each of the two network entities. While aspects herein are described with respect to dual connectivity implementations including a UE, a first network entity, and a second network entity, aspects of the present disclosure may likewise be applicable to multi-connectivity designs where a UE is connected to more than two network entities.

As described herein, the information exchanged between the two network entities may include (1) user plane parameter(s) and/or (2) RRC state information for the UE.

For example, a user plane, also referred to as a “data plane,” is used to carry network user traffic. More specifically, a user plane may exist between a UE and a network entity connected to the UE and may be configured to exchange data between the UE and the network entity. In cases where the UE is configured for dual connectivity and is connected to both a first network entity and a second network entity, a first user plane may exist between the UE and the first network entity and a second user plane may exist between the UE and the second network entity. In some aspects, user plane parameter(s) are determined for the first user plane between the first network entity and the UE and provided to the second network entity connected to the UE. In some aspects, user plane parameter(s) are determined for the second user plane between the second network entity and the UE and provided to the first network entity connected to the UE.

In some aspects, the user plane parameter(s) for the first user plane and/or the second user plane include uplink throughput (e.g., amount of uplink data transmitted over a period of time) and/or downlink throughput (e.g., amount of downlink data transmitted over a period of time) information. Specifically, a UE, while in a connected state with the first network entity, may be allocated one or more signaling radio bearers (SRBs) and/or one or more data radio bearers (DRBs) to exchange data/messages with the first network entity. The one or more SRBs may be used to carry registration and signaling for setup of the first user plane between the the UE and the first network entity. The one or more DRBs may be used to transport first user plane application data (1) from the UE to the first network entity (e.g., uplink) and/or (2) from the first network entity to the UE (e.g., downlink). Uplink throughput and/or downlink throughput may be measured for one or more DRBs associated with the first user plane, and then subsequently communicated to the second network entity.

Similarly, one or more SRBs and/or one or more DRBs may be allocated to the UE to exchange data/messages with the second network entity over the second user plane. Uplink throughput and/or downlink throughput may be measured for one or more DRBs associated with the second user plane, and then subsequently communicated to the first network entity.

In some aspects, the uplink throughput information communicated to the second network entity includes uplink throughput information measured for each of the one or more DRBs. For example, in a case where uplink throughput is measured for a first DRB, a second DRB, and a third DRB, three uplink throughput values may be communicated to the second network entity. In some other cases, the uplink throughput information communicated to the second network entity includes a total amount of uplink throughput measure for one or more DRBs. For example, for the case above, the uplink throughput measured for the first DRB, the second DRB, and the third DRB may be summed together, and the total uplink throughput (e.g., the sum) may be communicated to the second network entity. The same may be true (e.g., throughput information per DRB) for uplink throughput information communicated to the first network entity, downlink throughput information communicated to the second network entity, and/or downlink throughput information communicated to the first network entity.

In some other aspects, the uplink throughput information communicated to the second network entity includes one or more uplink throughput statistics. In particular, an uplink throughput statistic may be an average uplink throughput calculated based on the uplink throughput measured for one or more DRBs. For example, in a case where uplink throughput is measured for a first DRB, a second DRB, and a third DRB, an average of the three uplink throughput values may be calculated and communicated to the second network entity. In some other cases, the uplink throughput statistic is a median uplink throughput, a mode uplink throughput, etc. One or more similar uplink throughput statistics may be calculated for DRBs associated with the second user plane and communicated to the first network entity. Further, one or more similar downlink throughput statistics may be calculated for DRBs associated with the first user plane and communicated to the second network entity and/or calculated for DRBs associated with the second user plane and communicated to the first network entity.

A network entity receiving the uplink throughput information and/or downlink throughput information from the other network entity (e.g., the first network entity receiving the information associated with the second user plane or the second network entity receiving the information associated with the first user plane) may use this information for load balancing purposes. Specifically, using the received throughput information, the network entity may determine whether to offload a subset of the UE traffic (e.g., traffic originating from and/or intended for the UE) to the user plane between the UE and the other network entity (e.g., that transmitted the throughput information). As such, a technical benefit of communicating the throughput information between network entities (e.g., associated with different RANs) includes the ability of one of the network entities to make an informed decision about offloading traffic to help distribute the traffic load of the UE (e.g., between RANs), help prevent congestion in the RAN associated with the first network entity, help prevent congestion in the RAN associated with the second network entity, and/or the like.

For example, a first network entity receiving uplink throughput information and/or downlink throughput information (e.g., associated with one or more DRBs associated with a second user plane between a second network entity and a UE) from the second network entity, may determine whether to offload UE traffic for one or more DRBs associated with a first user plane between the first network entity and the UE. In some aspects, the first network entity makes this determination based on the uplink throughput information alone, the downlink throughput information alone, or both the uplink and downlink throughput information.

In some aspects, the first network entity makes this determination based on a pre-defined, desired distribution of UE traffic between RANs. For example, the first network entity may be associated with a first RAN (e.g., 5G RAN) and the second network entity may be associated with a second RAN (e.g., 6G RAN). Further, a pre-defined, desired distribution of UE traffic between the 5G RAN and 6G RAN may be 20% on 5G and 80% on 6G (e.g., for a single UE). Based on receiving the uplink throughput information and/or the downlink throughput information from the second network entity, the first network entity may determine if the UE traffic for all DRBs associated with the first user plane (e.g., between the first network entity and the UE) is less than 20%, more than 20%, or equal to 20% of the UE traffic for all DRBs associated with both the first user plane and second user plane). If the UE traffic for all DRBs associated with the first user plane is greater than 20%, then the first network entity may determine to offload a subset of the UE traffic (e.g., traffic for the UE and associated with one or more DRBs) from the first user plane to the second user plane. The subset of UE traffic offloaded may be equal to the amount of UE traffic for all DRBs associated with the first user plane that is greater than 20%. For example, if the UE traffic for all DRBs associated with the first user plane is 26%, then the first network entity may determine to offload ˜6% of the UE traffic from the first user plane to the second user plane.

In some aspects, the first network entity receiving uplink throughput information and/or downlink throughput information determines whether to offload UE traffic for one or more DRBs associated with the first user plane to the second user plane based on a maximum amount of UE traffic that can be exchanged over the first user plane. For example, an amount of UE traffic transmitted over the first user plane may, in some cases, be too much for the first network entity to handle (e.g., amount of UE traffic>maximum amount of UE traffic the first network entity is capable of handling in the uplink, downlink, or both). In such cases, the first network entity may determine to offload a subset of the UE traffic (e.g., traffic for the UE and associated with one or more DRBs) from the first user plane to the second user plane. The subset of UE traffic offloaded may be an amount such that the UE traffic over the first user plane, after offloading, is less than or equal to the maximum amount of UE traffic the first network entity is capable of handling.

In an effort to avoid frequent redistributions of UE traffic, in some aspects, to offload UE traffic from the first user plane to the second user plane, one or more conditions may need to be met. For example, the first network entity may initiate the offload of traffic from the first user plane to the second user plane (1) only if the amount of throughput over the first user plane changes by an amount greater than a minimum threshold amount of change over a period of time, (2) only if the amount of throughput over the second user plane changes by an amount greater than the minimum threshold amount of change over the period of time, (3) or both. For example, at a first time (e.g., t=0 seconds) the average uplink throughput information for the second user plane, communicated to the first network entity, may be equal to 70 megabits per second (Mbps). At a second time (e.g., t=10 seconds) the average uplink throughput information for the second user plane, communicated to the first network entity, may be equal to 20 Mbps. Thus, a change in the amount of uplink throughput may be equal to 20 Mbps over 10 seconds

$$( e . g . , \frac{\vert 20 Mbps - 70 Mbps \vert}{10 seconds - 0 seconds} = 5 Mbps / second ) .$$

If the minimum threshold amount of average uplink throughput change over a period of time is equal to 3 Mbps/second, the condition may be met, and the first network entity may offload a subset of the UE traffic over the first user plane to the second user plane.

In cases where the first network entity determines to offload a subset of the UE traffic from the first user plane to the second user plane, the first network entity may transmit, to the UE, an indication to offload traffic associated with DRB(s) of the first user plane to the second user plane. Similarly, in cases where the second network entity determines to offload a subset of the UE traffic from the second user plane to the first user plane, the second network entity may transmit, to the UE, an indication to offload traffic associated with DRB(s) of the second user plane to the first user plane.

In some aspects, the user plane parameter(s) for the first user plane and/or the second user plane include available uplink capacity and/or available downlink capacity information for each user plane (e.g., for the UE). For example, available uplink capacity may be equal to a maximum uplink throughput that can be achieved over the second user plane. The maximum uplink throughput that can be achieved over the second user plane may be calculated as the summation of uplink throughput measured for all DRBs associated with the second user plane. This available uplink capacity may be communicated to the first network entity. Similarly, available downlink capacity at the UE may be equal to a maximum downlink throughput that can be achieved over the second user plane. The maximum downlink throughput that can be achieved over the second user plane may be calculated as the summation of downlink throughput measured for all DRBs associated with the second user plane. This available downlink capacity may be communicated to the first network entity. Similar methods may also be used to calculate available uplink capacity and/or downlink capacity for the first user plane, and communicate the calculated available uplink capacity and/or downlink capacity information to the first network entity.

A network entity receiving the available uplink and/or downlink capacity information from the other network entity (e.g., the first network entity receiving the information associated with the second user plane or the second network entity receiving the information associated with the first user plane) may also use this information for load balancing purposes. Specifically, using the received capacity information, the network entity may determine whether to offload a subset of the UE traffic (e.g., traffic originating from and/or intended for the UE) to the user plane between the UE and the other network entity (e.g., that transmitted the throughput information). As such, similar to communicating throughput information, a technical benefit of communicating the capacity information between network entities (e.g., associated with different RANs) includes the ability of one of the network entities to make an informed decision about offloading traffic. Offloading traffic may help to distribute the load between RANs and/or help to reduce congestion. Methods for determining whether to offload a subset of the UE traffic based on the available uplink and/or downlink capacity information are similar to those described herein with respect to uplink and/or downlink throughput information.

In some aspects, the user plane parameter(s) for the first user plane and/or the second user plane include uplink packet delay and/or downlink packet delay information per user plane.

For example, uplink packet delay, for the first user plane, may be measured as the time delay between when a packet of data is transmitted by the UE, and when the packet is received by the first network entity. The time delay may be the over-the-air interface (OTA) delay measured at upper layer(s) (e.g., packet data convergence protocol (PDCP) layer and/or radio link control (RLC) layer). The uplink packet delay may be measured per DRB associated with the first user plane. In some aspects, the uplink packet delay information communicated to the second network entity is the uplink packet delay measured per DRB (e.g., for one or more DRBs associated with the first user plane). In some aspects, the uplink packet delay information communicated to the second network entity is the total uplink packet delay across two or more DRBs (e.g., a sum of the uplink packet delay measured per DRB for two or more DRBs). In some aspects, the uplink packet delay information communicated to the second network entity includes one or more uplink packet delay statistics. In particular, an uplink packet delay statistic may be an average, median, mode, etc. uplink packet delay calculated based on the uplink packet delay measured for one or more DRBs associated with the first user plane. Uplink packet delay, for the second user plane, may be measured, calculated, and/or communicated (e.g., to the first network entity) similar to the uplink packet delay for the first user plane.

Downlink packet delay, for the first user plane, may be measured as the time delay between when a packet of data is transmitted by the first network entity and when the packet is received by the UE. The time delay may be the OTA delay measured at upper layer(s) (e.g., PDCP layer and/or RLC layer). The downlink packet delay may be measured per DRB associated with the first user plane. In some aspects, the downlink packet delay information communicated to the second network entity is the downlink packet delay measured per DRB (e.g., for one or more DRBs associated with the first user plane). In some aspects, the downlink packet delay information communicated to the second network entity is the total downlink packet delay across two or more DRBs (e.g., a sum of the downlink packet delay measured per DRB for two or more DRBs). In some aspects, the downlink packet delay information communicated to the second network entity includes one or more downlink packet delay statistics. In particular, a downlink packet delay statistic may be an average, median, mode, etc. downlink packet delay calculated based on the downlink packet delay measured for one or more DRBs associated with the first user plane. Downlink packet delay, for the second user plane, may be measured, calculated, and/or communicated similar to the uplink packet delay for the first user plane.

A network entity receiving the uplink packet delay and/or downlink packet delay information from the other network entity (e.g., the first network entity receiving the information associated with the second user plane or the second network entity receiving the information associated with the first user plane) may use this information for packet duplication activation and/or deactivation. Packet duplication is the process of replicating packets and transmitting them through two or more pathways at the same time. Packet duplication may be used to (1) increase the likelihood of at least the packet or the duplicate(s) of the packet reaching the destination, even if other packet(s) are lost or delayed in route and/or (2) decrease the latency associated with transmission of the packet (e.g., improve quality of experience (QoE)). As such, technical benefits of packet duplication include increased communication reliability and performance and/or reduced latency. As used herein, packet duplication specifically refers the process of replicating a packet to be transmitted on the first user plane or the second user plane, and transmitting the packet on the first user plane or the second user plane and the replicated packet on the other of the first user plane or the second user plane.

A first network entity receiving packet delay information, from a second network entity (e.g., for one or more DRBs associated with a second user plane between the UE and the second network entity), may determine whether to activate packet duplication over the first user plane for packets exchanged over the second user plane based on the packet delay information. For instance, packet delay information communicated to first network entity indicating a large packet delay (e.g., uplink packet delay>uplink threshold packet delay and/or downlink packet delay>downlink threshold packet delay) may inform the first network entity that packet duplication over the first user plane, for packets exchanged over the second user plane, may be useful (e.g., to achieve a desired QoE threshold, achieve a desired latency threshold, etc.). Accordingly, the first network entity may activate the packet duplication, and a technical benefit of reduced latency may be realized. Further, in cases where packet duplication is already activated over the first user plane, packet delay information communicated to first network entity that indicates a small packet delay (e.g., uplink packet delay≤uplink threshold packet delay and/or downlink packet delay≤downlink threshold packet delay) may inform the first network entity that packet duplication over the first user plane, for packets exchanged over the second user plane, is no longer useful (e.g., to achieve the desired QoE threshold, achieve the desired latency threshold, etc.). Accordingly, the first network entity may deactivate the packet duplication. As such, signaling overhead may be reduced, as well as congestion in the RAN (e.g., two technical benefits of receiving the packet delay information, in this scenario).

In some aspects, the user plane measurements for the first user plane and/or the second user plane include packet loss rate information per DRB (e.g., for the uplink or downlink).

For example, packet loss rate for the first user plane may be measured as the percentage of packets lost with respect to packets sent over the first user plane (e.g., in the uplink or downlink). The packet loss rate may be measured per DRB associated with the first user plane. In some aspects, the packet loss rate information communicated to the second network entity is the packet loss rate measured per DRB (e.g., for one or more DRBs associated with the first user plane). In some aspects, the packet loss rate information communicated to the second network entity is the total packet loss rate across two or more DRBs (e.g., a sum of the packet loss rate measured per DRB for two or more DRBs). In some aspects, the packet loss rate information communicated to the second network entity includes one or more packet loss rate statistics. In particular, a packet loss rate statistic may be an average, median, mode, etc. packet loss rate calculated based on the packet loss rate measured for one or more DRBs associated with the first user plane. Packet loss rate, for the second user plane, may be measured, calculated, and/or communicated (e.g., to the first network entity) similar to the packet loss rate for the first user plane (e.g., per DRB).

A network entity receiving the packet loss rate information from the other network entity (e.g., the first network entity receiving the information associated with the second user plane or the second network entity receiving the information associated with the first user plane) may use this information for packet duplication activation and/or deactivation (e.g., in addition to, or alternative to, using packet delay information, as described above). As described herein, a technical benefit of packet duplication is increased communication reliability and performance.

In some aspects, a first network entity receiving packet delay information and/or packet loss rate information, from a second network entity (e.g., for one or more DRBs associated with a second user plane between the UE and the second network entity), may transmit a request for an activation or a deactivation of packet duplication over the second user plane of packets exchanged over the first user plane. For example, if the packet delay information indicates a low packet delay and/or the packet loss rate information indicates a low packet loss rate for the second plane (e.g., for a DRB), the first network entity may determine to activate packet duplication over the second user plane for packets transmitted over the first user plane. The first network entity may make this determination, for example, where the packet delay and/or packet loss rate for the first user plane is high. Transmission of duplicate copies of packets transmitted over the first user plane, over the second user plane, may help to increase the likelihood of such packets reaching their intended receiver, and/or help to reduce the transmission delay associated with such packets.

As described above, the information exchanged between the two network entities may not only include user plane parameter(s), but also RRC state information for the UE. The RRC state information may be exchanged between the two network entities in addition to the user plane parameter(s) or alternative to the user plane parameter(s). RRC state information shared between the network entities may include RRC state information for one or more UEs that previously established an RRC connection with the first network entity and/or the second network entity.

For example, the UE may have previously established an RRC connection with the first network entity (e.g., associated with the first RAN) and an RRC connection with the second network entity (e.g., associated with the second RAN) (e.g., in the dual connectivity implementation). After establishing an RRC connection with the first network entity and the second network entity, the UE may be operating in a first connected state with the first network entity and in a second connected state with the the second network entity. The first network entity may communicate this first connected state of the UE in the first RAN to the second network entity. Additionally, or alternatively, the second network entity may communicate this second connected state of the UE in the second RAN to the first network entity.

In some aspects, the RRC state of the UE in the first RAN changes from the first connected state to a first inactive state (e.g., RRC connection established but no active communication) or a first idle state (e.g., no RRC connection established). The first network entity may communicate this first inactive state or this first idle state of the UE in the first RAN to the second network entity. In some cases, the first network entity communicates the RRC state of the UE in the first RAN, to the second network entity, when the RRC state of the UE in the first RAN changes.

Similarly, in some aspects, the RRC state of the UE in the second RAN changes from the second connected state to a second inactive state (e.g., RRC connection established but no active communication) or a second idle state. The second network entity may communicate this second inactive state or this second idle state of the UE in the first RAN to the second network entity. In some cases, the second network entity communicates the RRC state of the UE in the second RAN, to the first network entity, when the RRC state of the UE in the second RAN changes.

A network entity receiving an RRC state of the UE from the other network entity (e.g., the first network entity receiving the information associated with the second user plane or the second network entity receiving the information associated with the first user plane) may use this RRC state information in a variety of ways.

For example, in some aspects, the network entity receiving an RRC state of the UE uses this RRC state information to avoid performing handover. As an illustrative example, as described above, the UE may have an established connection with the first network entity (e.g., associated with the first RAN) and the second network entity (e.g., associated with the second RAN). The second network entity may communicate (e.g., transmit an indication of) the RRC state of the UE in the second RAN, to the first network entity. The RRC state of the UE in the second RAN may be a connected state, indicating that the UE is connected to the second network entity in the second RAN and that the UE is able to communicate in a serving cell of the second RAN. The serving cell may include only a primary cell (e.g., UE is not configured with carrier aggregation) or a set of cells comprising the primary cell and one or more secondary cells (e.g., UE is configured with carrier aggregation). The primary cell serves as the main point of communication between the UE and the second network entity. The one or more secondary cells complement the primary cell and are used to enhance network performance and provide additional bandwidth in the second RAN for the UE.

Some time after receiving the RRC state of the UE, the first network entity may determine that the UE is unable to communicate in a serving cell of the first RAN and thus needs to be handed over to a target cell. For example, a radio link between the first network entity and the UE may become compromised/lost due to, for example, poor link quality, interference, beam failure, etc. A UE unable to communicate in the serving cell of the first RAN may need to be handed over to a target cell. Handover is the process of transferring an ongoing communication session of the UE from the source cell (e.g., the serving cell of the first RAN) to a target cell, to assist in the seamless connectivity and continuity of service for the UE. Handover may include the performance of a random access channel (RACH) procedure to allow the UE to synchronize to the target cell.

Instead of performing handover from the serving cell of the first RAN to a target cell, however, the first network entity may request that the UE offload its traffic over the first user plane to the second user plane (e.g., transmit an indication to offload its traffic). Specifically, because the first network entity knows that the UE has an established connection with the second network entity, handover of the UE to another cell may be avoided (e.g., in cases where the handover involves performing RACH on the target cell, for example, the UE needs to perform RACH if the UE does not have uplink timing alignment (TA) information regarding the target cell). Instead, the first network entity may continue communication with the second network entity and move all of its traffic to the second user plane between the UE and the second network entity. This helps to avoid the performance of resource-intensive procedures, such as RACH, as well as may result in realizing a technical benefit of lower latency of access than if handover was performed.

In some aspects, the network entity receiving an RRC state of the UE uses this RRC state information for load balancing and/or energy savings purposes. As such, technical benefits of communicating the RRC state information may include better distribution of load, reduced congestion, reduced power at a network entity, and/or the like.

For example, a first network entity receiving an RRC state (e.g., connected state) of the UE may, in some cases, determine to offload UE traffic over the first user plane between the first network entity and the UE, to the second user plane between the second network entity and the UE. The first network entity may make this determination because the UE has an already established connection with the second network entity.

As another example, a first network entity may receive an RRC state of the UE indicating that the UE is operating in a connected state with the second network entity. The first network entity may also receive an RRC state of one or more other UEs (e.g., connected to the first network entity) indicating that the one or more other UEs (e.g., 3 other UEs) are also operating in a connected state with the second network entity. The first network entity may determine that a total number of the one or more other UEs and the UE is less than a threshold (e.g., 1 UE+3 other UEs=4 UEs<threshold # of UEs), and based on this determination, may determine to offload the UE traffic for the UE and the one or more other UEs from first user planes configured for exchanging information between each UE and the first network entity to second user planes configured for exchanging information between each UE and the second network entity (e.g., each UE may have its own user plane, but the user planes of all UEs may all share the resources of the cell that belongs to the first network entity or the second network entity). In other words, based on only a small number of UEs (e.g., # of UEs<threshold # of UEs) being connected to the first network entity, which are also connected to the second network entity, the first network entity may request that these UEs offload their traffic over the first user planes to the second user planes. Offloading of UE traffic from the first user planes to the second user planes may allow the first network entity to enter into a sleep mode (e.g., a low power consuming mode), to thereby reduce energy consumption at the first network entity and in the first RAN (e.g., network energy savings). The first network entity may enter into a sleep mode after all UE traffic is moved to the second user planes. Additionally, in some cases, the first network entity may determine to offload the UE traffic for the UE and the other UE(s) from the first user planes to the second user planes based on a total amount of traffic of the UE and the other UE(s) (e.g., amount of traffic<threshold amount of traffic).

In addition to, or alternative to, the exchange of user plane parameter(s) and/or RRC state information between network entities, in some aspects, a carrier aggregation configuration for the UE is exchanged between network entities.

Carrier aggregation is a technique used in wireless communication to increase the data rate per UE, whereby multiple frequency blocks (referred to as “component carriers”) are assigned to the same UE for data transmission and/or reception. Carrier aggregation enables multiple component carriers to be aggregated and allows for simultaneous communication, using the multiple component carriers, between the UE and a network entity (e.g., to/from the UE) to thereby increase the frequency bandwidth for communication. When carrier aggregation is used, one serving cell exists per component carrier. However, the RRC connection is only handled by one cell. e.g., the primary cell, served by a primary component carrier. The other component carriers assigned to the UE are all referred to as secondary component carriers, which serve secondary serving cells. Secondary cells may be activated and/or deactivated. For example, the first network entity may configure the UE with one or more component carriers, but deactivate all component carriers (and their associated cells) except the primary component carrier. When there is a large amount of data to delivered to the UE in the downlink, the first network may activate one or more secondary component carriers, and accordingly the secondary cell(s) associated with the one or more secondary component carriers, to maximize downlink throughput.

In some aspects, a carrier aggregation configuration for the UE, in the first RAN associated with the first network entity, may be communicated to the second network entity. The carrier aggregation configuration for the UE may include information about activated and/or deactivated secondary cells. Based on the carrier aggregation configuration, the second network entity may estimate (1) an uplink throughput statistic (e.g., an average uplink throughput based on the current activated and/or deactivated secondary cells) for the first user plane, (2) a downlink throughput statistic (e.g., an average downlink throughput based on the current activated and/or deactivated secondary cells) for the first user plane. (3) an achievable uplink throughput statistic (e.g., assuming all secondary cells are activated) for the first user plane, and/or (4) an achievable downlink throughput statistic (e.g., assuming all secondary cells are activated) for the first user plane. The uplink throughput statistic, the downlink throughput statistic, the achievable uplink throughput statistic, and/or the achieveable downlink throughput statistic for the first user plane may be used by the second network entity for load balancing purposes, as described in detail above.

Similarly, in some aspects, a carrier aggregation configuration for the UE, in the second RAN associated with the second network entity, may be communicated to the first network entity. The carrier aggregation configuration communicated to the first network entity may allow the first network entity to estimate an uplink throughput statistic, a downlink throughput statistic, an achievable uplink throughput statistic, and/or an achieve downlink throughput statistic for the second user plane. The uplink throughput statistic, the downlink throughput statistic, the achievable uplink throughput statistic, and/or the achieve downlink throughput statistic for the second user plane may be used by the first network entity for load balancing purposes, as described in detail above.

In some aspects, the UE may only have an established connection with one of the two network entities. For example, the UE may be connected to the first network entity (e.g., associated with the first RAN) and not the second network entity (e.g., associated with the second RAN). Based on uplink throughput information and/or downlink throughput information for the first user plane between the UE and the first network entity, the UE may determine to establish a connection with the second network entity. After establishing the connection with the second network entity, the UE may determine to move some of its traffic (e.g., protocol data unit (PDU) session(s)), associated with one or more DRBs associated with the first user plane, to the second user plane between the UE and the second network entity.

### Example Operations of Entities in a Communications Network to Share Information Between RANs

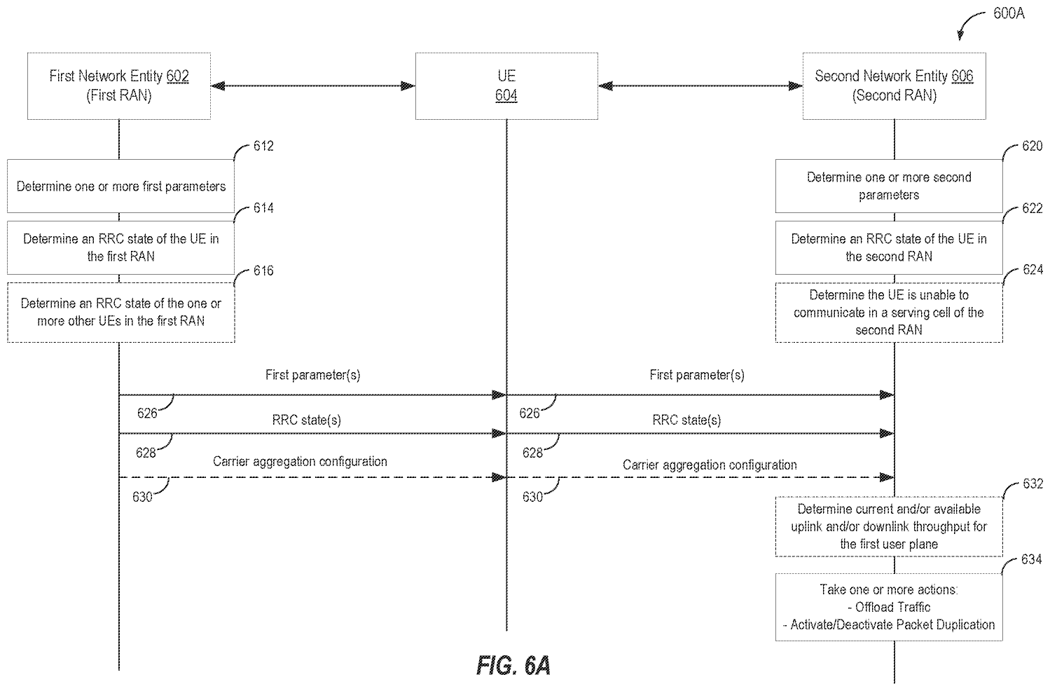

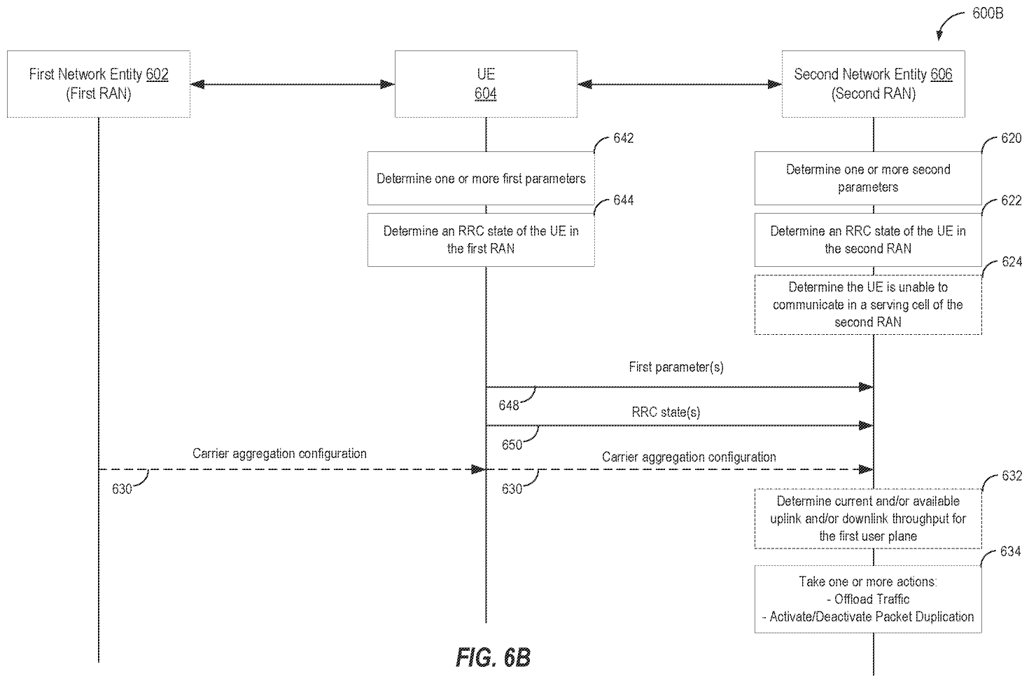

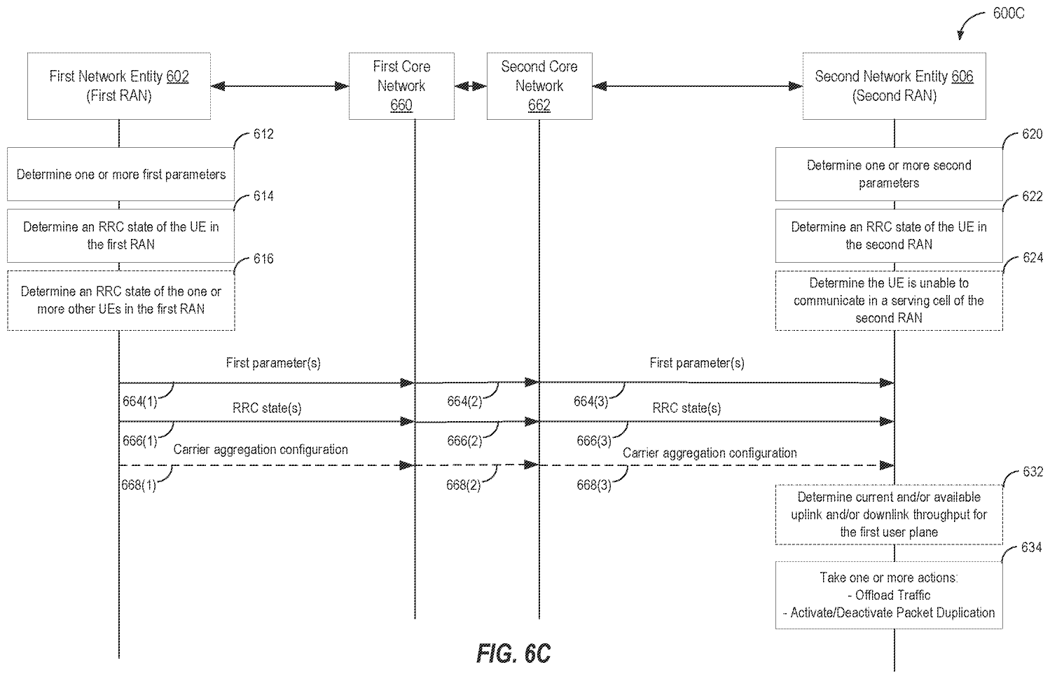

FIGS. 6A-6C depict process flows 600A, 600B, 600C, respectively, for communications between a first network entity 602 (e.g., associated with a first RAN (e.g., 5G RAN)), a UE 604, and a second network entity 606 (e.g., associated with a second RAN (e.g., 6G RAN)). In some aspects, the first network entity 602 may be an example of the BS 102 depicted and described with respect to FIGS. 1 and 3 or a disaggregated base station depicted and described with respect to FIG. 2. In some aspects, the second network entity 606 may also be an example of the BS 102 depicted and described with respect to FIGS. 1 and 3 or a disaggregated base station depicted and described with respect to FIG. 2. Similarly, the UE 604 may be an example of UE 104 depicted and described with respect to FIGS. 1 and 3. However, in other aspects, UE 604 may be another type of wireless communications device and first network entity 602 and/or second network entity 606 may be another type of network entity or network node, such as those described herein.

Process flows 600A. 600B, and 600C illustrate example signaling used to exchange information between RANs, and more specifically, between first network entity 602 associated with the first RAN and second network entity 606 associated with the second RAN. As described above, the information exchanged between first network entity 602 and second network entity 606 may include (1) user plane parameter(s) and/or (2) RRC state information for UE 604. Further, in some cases, the information exchanged between first network entity 602 and second network entity 606 carrier aggregation configuration information for the UE.

In some aspects, illustrated in FIGS. 6A and 6B, the user plane parameter(s) and/or the RRC state information for UE 604 is exchanged between first network entity 602 and second network entity 606 via UE 604. In some cases, illustrated in FIG. 6A, the user plane parameter(s) and/or the RRC state information for UE 604 is determined by one of the network entities, while in FIG. 6B, the user plane parameter(s) and/or the RRC state information for UE 604 is determined by UE 604. Although FIGS. 6A and 6B illustrate the communication of information to second network entity 606, in other examples (not illustrated), the information may be communicated to first network entity 602. Further, although FIG. 6A illustrates first network entity 602 determining the user plane parameter(s) and/or the RRC state information for UE 604, in other example (not illustrated), the user plane parameter(s) and/or the RRC state information for UE 604 may be determined by second network entity 606. In some aspects, as illustrated in FIG. 6C, the user plane parameter(s) and/or the RRC state information for the UE is exchanged between first network entity 602 and second network entity 606 via a CN of the first RAN associated with first network entity 602 and a CN of the second RAN associated with second network entity 606.

For example, as illustrated in process flow 600A of FIG. 6A, first network entity 602 determines, at 612, one or more first parameters based on measurements for a first user plane configured for exchanging information between UE 604 and first network entity 602. Determining the first parameter(s) may include performing measurement(s) for the first user plane and/or calculating statistic(s) for the first user plane. As such, the first parameter(s) may include uplink throughput(s) associated with one or more DRBs associated with the first user plane, downlink throughput(s) associated with one or more DRBs associated with the first user plane, uplink packet delay(s) associated with one or more DRBs associated with the first user plane, downlink packet delay(s) associated with one or more DRBs associated with the first user plane, uplink throughput statistic(s), downlink throughput statistic(s), uplink packet delay statistic(s), downlink packet delay statistic(s), packet loss rate statistic(s), available uplink capacity associated with one or more DRBs associated with the first user plane, available downlink capacity associated with one or more DRBs associated with the first user plane, and/or the like.

Further, at 614, first network entity 602 determines an RRC state of UE 604 in the first RAN. For example, first network entity 602 may determine that UE 604 is in a connected state in the first RAN (e.g., such that first network entity 602 is able to communicate with UE 604). Optionally, at 616, first network entity 602 determines an RRC state of one or more other UEs in the first RAN. For example, three other UEs may have an RRC connection with first network entity 602; thus, at 616, first network entity 602 may determine that the three other UEs are each operating in a connected state in the first RAN.

At 626 and 628, respectively, first network entity 602, sends first parameter(s) (e.g., determined at 612) and RRC state(s) (e.g., determined at 614 and/or 616) to UE 604. UE 604 acts as a relay to receive the first parameter(s) and the RRC state(s) and forward the first parameter(s) and the RRC state(s) to second network entity 606, at 626 and 628, respectively.

Based on receiving the first parameter(s) and/or the RRC state(s), second network entity 606 may, at 634, take one or more actions. As described above, the one or more actions may include offloading traffic for one or more DRBs associated with a second user plane between UE 604 and second network entity 606 to the first user plane. Additionally or alternatively, the one or more actions may include activating and/or deactivating packet duplication.

In some aspects, second network entity 606 takes one or more actions, at 634, further based on second parameter(s) for the second user plane and/or an RRC state of UE 604 in the second RAN (e.g., in addition to first parameter(s) and RRC state(s) received from first network entity 602). For example, at 620, first network entity 602 determines one or more second parameters based on measurements for the second user plane configured for exchanging information between UE 604 and second network entity 606. Determining the second parameter(s) may include performing measurement(s) for the second user plane and/or calculating statistic(s) for the second user plane. Further, at 622, second network entity determines an RRC state of UE 604 in the second RAN.

In some aspects, at 624, second network entity 606 also determines that UE 604 is unable to communicate in a serving cell of the second RAN. Second network entity 606 may optionally use this information when determining to take one or more actions at 634.

Optionally, at 630, first network entity 602 sends a carrier aggregation configuration for UE 604 in the first RAN to UE 604, which then forwards this carrier aggregation configuration for UE 604 to second network entity 606. Thus, at 632, second network entity 606 may determine current and/or available uplink and/or downlink throughput for the first user plane. Second network entity 606 may also use this information when determining what actions to take, at 634.

Process flow 600B of FIG. 6B is similar to process flow 600A of FIG. 6A; however, instead of first network entity 602 sending the first parameter(s) for the first user plane and an RRC state of UE 604 in the first RAN, to second network entity 606, UE 604 is responsible for sending this information.

For example, as illustrated in process flow 600B of FIG. 6B, UE 604 determines, at 642, one or more first parameters based on measurements for the first user plane configured for exchanging information between UE 604 and first network entity 602. Determining the first parameter(s) may include performing measurement(s) for the first user plane and/or calculating statistic(s) for the first user plane. Further, at 644, UE 604 determines whether it is operating in a connected state, an idle state, or an inactive state in the first RAN. At 648 and 650, UE 604 sends the first parameter(s) (e.g., determined at 642) and the RRC state of UE 604 in the first RAN (e.g., determined at 644) to second network entity 606, respectively.

Process flow 600C of FIG. 6C is also similar to process flow 600A of FIG. 6A; however, instead of first network entity 602 sending the first parameter(s) for the first user plane and an RRC state of UE 604 in the first RAN, to second network entity 606 via UE 604, this information is sent via a first CN 660 (of the first RAN) and a second CN 662 (of the second RAN).

For example, as illustrated in process flow 600C of FIG. 6C, first network entity 602 sends, at 664(1) and 666(1), respectively, the first parameter(s) (e.g., determined at 612) and the RRC state(s) (e.g., determined at 614 and/or 616) to first CN 660. First CN 660 then sends, at 664(2) and 666(2), respectively, the first parameter(s) and the RRC state(s) to CN 662. CN 662 then sends this information to second network entity 606, at 664(3) and 666(3), respectively.

Carrier configuration information may also be shared between first network entity 602 and second network entity 606 via first CN 660 and second CN 662. For example, as illustrated in process flow 600C of FIG. 6C, first network entity 602 sends, at 668(1), the carrier aggregation configuration to first CN 660. First CN 660 then sends, at 668(2), the carrier aggregation configuration to CN 662. CN 662 then sends this carrier aggregation configuration to second network entity 606, at 668(3).

### Example Operations for Information Sharing Between RANs

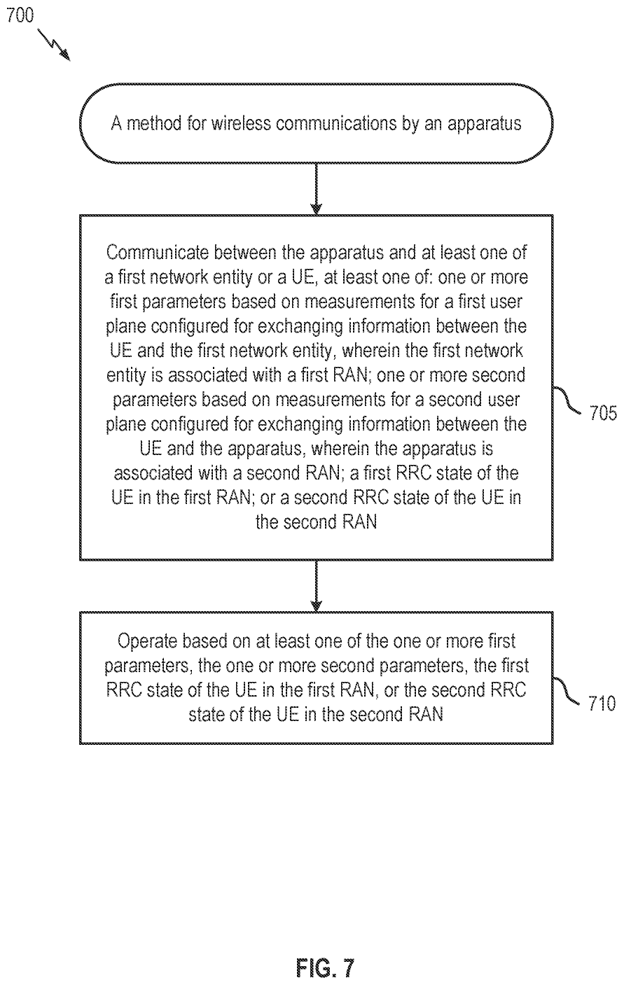

FIG. 7 shows a method 700 for wireless communications by an apparatus, such as BS 102 of FIGS. 1 and 3, or a disaggregated base station as discussed with respect to FIG. 2.

Method 700 begins at step 705 with communicating between the apparatus and at least one of a first network entity or a UE, at least one of: one or more first parameters based on measurements for a first user plane configured for exchanging information between the UE and the first network entity, wherein the first network entity is associated with a first RAN; one or more second parameters based on measurements for a second user plane configured for exchanging information between the UE and the apparatus, wherein the apparatus is associated with a second RAN; a first RRC state of the UE in the first RAN; or a second RRC state of the UE in the second RAN.

Method 700 then proceeds to step 710 with operating based on at least one of the one or more first parameters, the one or more second parameters, the first RRC state of the UE in the first RAN, or the second RRC state of the UE in the second RAN.

In certain aspects, step 705 includes transmitting the one or more second parameters comprising at least one of: one or more uplink throughputs associated with one or more DRBs associated with the second user plane; one or more downlink throughputs associated with the one or more DRBs; one or more uplink packet delays associated with the one or more DRBs; one or more downlink packet delays associated with the one or more DRBs; or one or more packet loss rates associated with the one or more DRBs.

In certain aspects, method 700 further includes measuring at least one of: the one or more uplink throughputs; the one or more downlink throughputs; the one or more uplink packet delays; the one or more downlink packet delays; or the one or more packet loss rates.

In certain aspects, step 705 includes transmitting the one or more second parameters comprising at least one of: one or more uplink throughput statistics for one or more uplink throughputs associated with one or more DRBs associated with the second user plane; one or more downlink throughput statistics for one or more downlink throughputs associated with the one or more DRBs; one or more uplink packet delay statistics for one or more uplink packet delays associated with the one or more DRBs; one or more downlink packet delay statistics for one or more downlink packet delays associated with the one or more DRBs; or one or more packet loss rate statistics for one or more packet loss rates associated with the one or more DRBs.

In certain aspects, step 705 includes transmitting the one or more second parameters comprising at least one of an available uplink capacity associated with one or more DRBs associated with the second user plane or an available downlink capacity associated with the one or more DRBs associated with the second user plane.

In certain aspects, step 705 includes transmitting, to the first network entity, at least one of the one or more second parameters or the second RRC state.

In certain aspects, transmitting, to the first network entity, at least one of the one or more second parameters or the second RRC state, comprises transmitting, to the first network entity, at least one of the one or more second parameters or the second RRC state via: the UE, or a CN of the first RAN and a CN of the second RAN.

In certain aspects, method 700 further includes transmitting, to the first network entity, a request for an activation or a deactivation of packet duplication over: the first user plane of packets exchanged over the second user plane; or the second user plane of packets exchanged over the first user plane.

In certain aspects, method 700 further includes transmitting, to the first network entity, a carrier aggregation configuration.

In certain aspects, communicating at least one of the one or more first parameters, the one or more second parameters, the first RRC state, or the second RRC state, comprises receiving, from the UE or the first network entity, at least one of the one or more first parameters or the first RRC state.

In certain aspects, the one or more first parameters comprise at least one of: one or more uplink throughputs associated with one or more DRBs associated with the first user plane; one or more downlink throughputs associated with the one or more DRBs; one or more uplink packet delays associated with the one or more DRBs; one or more downlink packet delays associated with the one or more DRBs; one or more a packet loss rates associated with the one or more DRBs; an available uplink capacity associated with the one or more DRBs; or an available downlink capacity associated with the one or more DRBs.

In certain aspects, the one or more first parameters comprise at least one of: one or more uplink throughput statistics for one or more uplink throughputs associated with one or more DRBs associated with the first user plane; one or more downlink throughput statistics for one or more downlink throughputs associated with the one or more DRBs; one or more uplink packet delay statistics for one or more uplink packet delays associated with the one or more DRBs; one or more downlink packet delay statistics for one or more downlink packet delays associated with the one or more DRBs; or one or more packet loss rate statistics for one or more packet loss rates associated with the one or more DRBs.

In certain aspects, receiving, from the first network entity, at least one of the one or more first parameters or the first RRC state, comprises receiving, from the first network entity, at least one of the one or more first parameters or the first RRC state via: the UE, or a CN of the first RAN and a CN of the second RAN.

In certain aspects, operating based on the one or more first parameters or the first RRC state of the UE in the first RAN, comprises transmitting, to the UE, an indication to offload traffic associated with one or more DRBs associated with the second user plane to the first user plane.

In certain aspects, communicating at least one of the one or more first parameters, the one or more second parameters, the first RRC state, or the second RRC state, comprises receiving, from the UE or the first network entity, the one or more first parameters; and the method 700 further comprises: determining the one or more second parameters for the second user plane; and determining to offload the traffic based on at least one of: the one or more second parameters, the one or more first parameters, a first percentage of UE traffic configured to exchange over the first user plane; a second percentage of UE traffic configured to exchange over the second user plane; or a maximum amount of UE traffic that can be exchanged over the second user plane.

In certain aspects, operating based on the first RRC state of the UE in the first RAN comprises transmitting, to multiple UEs including the UE, an indication to offload traffic, for the multiple UEs, associated with one or more DRBs associated with the second user plane to the first user plane.

In certain aspects, communicating at least one of the one or more first parameters, the one or more second parameters, the first RRC state, or the second RRC state, comprises receiving, from the UE or the first network entity, the first RRC state; and the method further comprises: receiving an RRC state of one or more other UEs of the multiple UEs; determining a total number of the one or more other UEs and the UE is less than a threshold; and determining to offload the traffic for the multiple UEs from the second user plane to the first user plane based on the total number of the one or more other UEs and the UE being less than the threshold.

In certain aspects, operating based on the first RRC state of the UE in the first RAN comprises: determining that the UE is unable to communicate in a serving cell of the second RAN; and transmitting, to the UE, an indication to offload traffic associated with one or more DRBs associated with the second user plane to the first user plane.

In certain aspects, operating based on the one or more first parameters or the first RRC state of the UE in the first RAN comprises activating or deactivating packet duplication over: the second user plane of packets exchanged over the first user plane; or the first use plane of packets exchanged over the second user plane.

In certain aspects, method 700 further includes receiving, from the first network entity, a request for an activation or a deactivation of packet duplication over: the second user plane of packets exchanged over the first user plane; or the first user plane of packets exchanged over the second user plane.

In certain aspects, method 700 further includes receiving, from the first network entity, a carrier aggregation configuration.

In certain aspects, method 700 further includes estimating, based on the carrier aggregation configuration, at least one of: an uplink throughput statistic for the first user plane; a downlink throughput statistic for the first user plane; an achievable uplink throughput statistic for first user plane; or an achievable downlink throughput statistic for the first user plane.

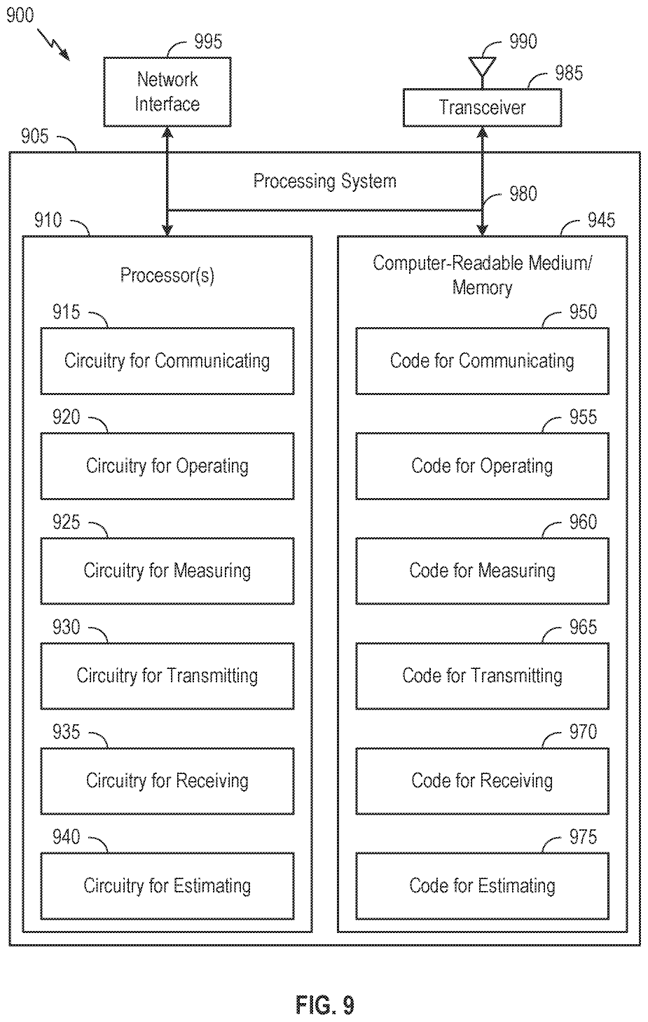

In certain aspects, method 700, or any aspect related to it, may be performed by an apparatus, such as communications device 900 of FIG. 9, which includes various components operable, configured, or adapted to perform the method 700. Communications device 900 is described below in further detail.

Note that FIG. 7 is just one example of a method, and other methods including fewer, additional, or alternative steps are possible consistent with this disclosure.

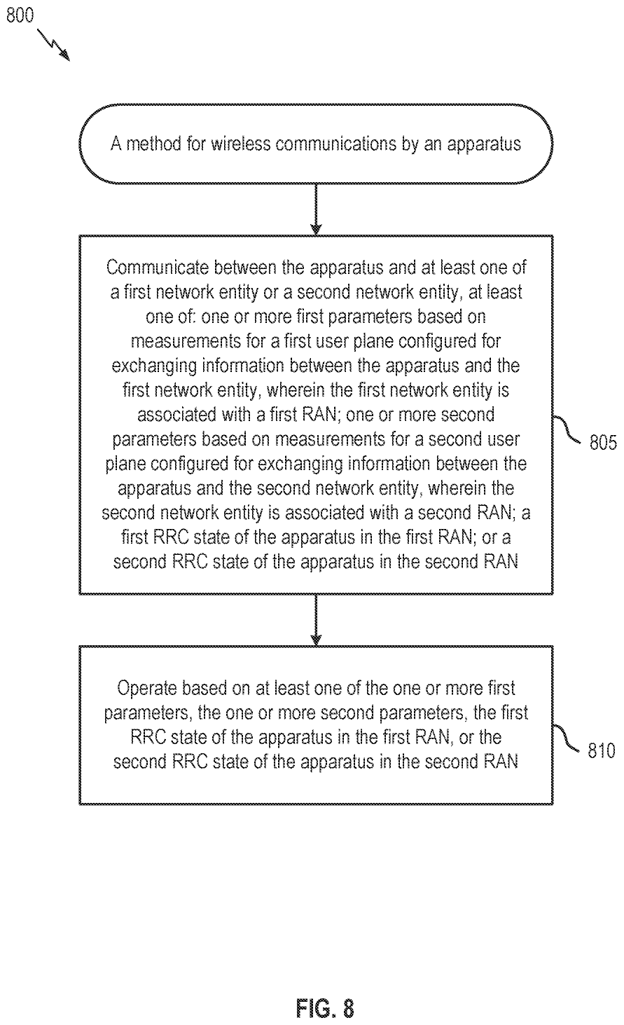

FIG. 8 shows a method 800 for wireless communications by an apparatus, such as UE 104 of FIGS. 1 and 3.

Method 800 begins at step 805 with communicating between the apparatus and at least one of a first network entity or a second network entity, at least one of: one or more first parameters based on measurements for a first user plane configured for exchanging information between the apparatus and the first network entity, wherein the first network entity is associated with a first RAN; one or more second parameters based on measurements for a second user plane configured for exchanging information between the apparatus and the second network entity, wherein the second network entity is associated with a second RAN; a first RRC state of the apparatus in the first RAN; or a second RRC state of the apparatus in the second RAN.

Method 800 then proceeds to step 810 with operating based on at least one of the one or more first parameters, the one or more second parameters, the first RRC state of the apparatus in the first RAN, or the second RRC state of the apparatus in the second RAN.

In certain aspects, step 805 includes at least one of: transmitting the one or more first parameters to the second network entity, the one or more first parameters comprising at least one of: one or more first uplink throughputs associated with one or more first DRBs associated with the first user plane; one or more first downlink throughputs associated with the one or more first DRBs; one or more first uplink packet delays associated with the one or more first DRBs; one or more first downlink packet delays associated with the one or more first DRBs; one or more first packet loss rates associated with the one or more first DRBs; an available first uplink capacity associated with the one or more first DRBs; or an available first downlink capacity associated with the one or more first DRBs; or transmitting the one or more second parameters to the second network entity, the one or more second parameters comprising at least one of: one or more second uplink throughputs associated with one or more second DRBs associated with the second user plane; one or more second downlink throughputs associated with the one or more second DRBs; one or more second uplink packet delays associated with the one or more second DRBs; one or more second downlink packet delays associated with the one or more second DRBs; one or more second packet loss rates associated with the one or more second DRBs; an available second uplink capacity associated with the one or more second DRBs; or an available second downlink capacity associated with the one or more second DRBs.

In certain aspects, method 800 further includes measuring at least one of: the one or more first uplink throughputs; the one or more first downlink throughputs; the one or more first uplink packet delays; the one or more first downlink packet delays; the one or more first packet loss rates; the one or more second uplink throughputs; the one or more second downlink throughputs; the one or more second uplink packet delays; the one or more second downlink packet delays; or the one or more second packet loss rates.

In certain aspects, method 800 further includes receiving, from the first network entity, at least one of: the one or more first uplink throughputs; the one or more first downlink throughputs; the one or more first uplink packet delays; the one or more first downlink packet delays: the one or more first packet loss rates; the available first uplink capacity: or the available first downlink capacity.

In certain aspects, method 800 further includes receiving, from the second network entity, at least one of: the one or more second uplink throughputs: the one or more second downlink throughputs; the one or more second uplink packet delays; the one or more second downlink packet delays; the one or more second packet loss rates; the available second uplink capacity; or the available second downlink capacity.

In certain aspects, step 805 includes at least one of: transmitting the one or more first parameters to the second network entity, the one or more first parameters comprising at least one of: one or more first uplink throughput statistics for one or more first uplink throughputs associated with one or more first DRBs associated with the first user plane: one or more first downlink throughput statistics for one or more first downlink throughputs associated with the one or more first DRBs; one or more first uplink packet delay statistics for one or more first uplink packet delays associated with the one or more first DRBs; one or more first downlink packet delay statistics for one or more first downlink packet delays associated with the one or more first DRBs; or one or more first packet loss rate statistics for one or more first packet loss rates associated with the one or more first DRBs: or transmitting the one or more second parameters to the first network entity, the one or more second parameters comprising at least one of: one or more second uplink throughput statistics for one or more second uplink throughputs associated with one or more second DRBs associated with the second user plane; one or more second downlink throughput statistics for one or more second downlink throughputs associated with the one or more second DRBs; one or more second uplink packet delay statistics for one or more second uplink packet delays associated with the one or more second DRBs; one or more second downlink packet delay statistics for one or more second downlink packet delays associated with the one or more second DRBs; or one or more second packet loss rate statistics for one or more second packet loss rates associated with the one or more second DRBs.

In certain aspects, method 800 further includes receiving, from the first network entity, at least one of: the one or more first uplink throughput statistics; the one or more first downlink throughput statistics; the one or more first uplink packet delay statistics; the one or more first downlink packet delay statistics; or the one or more first packet loss rate statistics.

In certain aspects, method 800 further includes receiving, from the second network entity, at least one of: the one or more second uplink throughput statistics; the one or more second downlink throughput statistics; the one or more second uplink packet delay statistics; the one or more second downlink packet delay statistics; or the one or more second packet loss rate statistics.

In certain aspects, step 805 includes at least one of: transmitting the first RRC state to the second network entity; or transmitting the second RRC state to the first network entity.

In certain aspects, step 805 includes at least one of: receiving the first RRC state to the first network entity; or receiving the second RRC state to the second network entity.

In certain aspects, method 800 further includes at least one of: transmitting, to the first network entity, a first carrier aggregation configuration of the apparatus in the first RAN; or transmitting, to the second network entity, a second carrier aggregation configuration of the apparatus in the second RAN.

In certain aspects, method 800 further includes relaying, between the first network entity and the second network entity, a request for an activation or a deactivation of packet duplication over: the first user plane of packets exchanged over the second user plane: or the second user plane of packets exchanged over the first user plane.

In certain aspects, method 800 further includes relaying, between the first network entity and the second network entity, an indication to: offload traffic associated with one or more first DRBs associated with the first user plane to the second user plane; or offload traffic associated with one or more second DRBs associated with the second user plane to the first user plane.

In certain aspects, method 800 further includes offloading traffic associated with one or more first DRBs associated with the first user plane to the second user plane.

In certain aspects, method 800 further includes offloading traffic associated with one or more second DRBs associated with the second user plane to the first user plane.

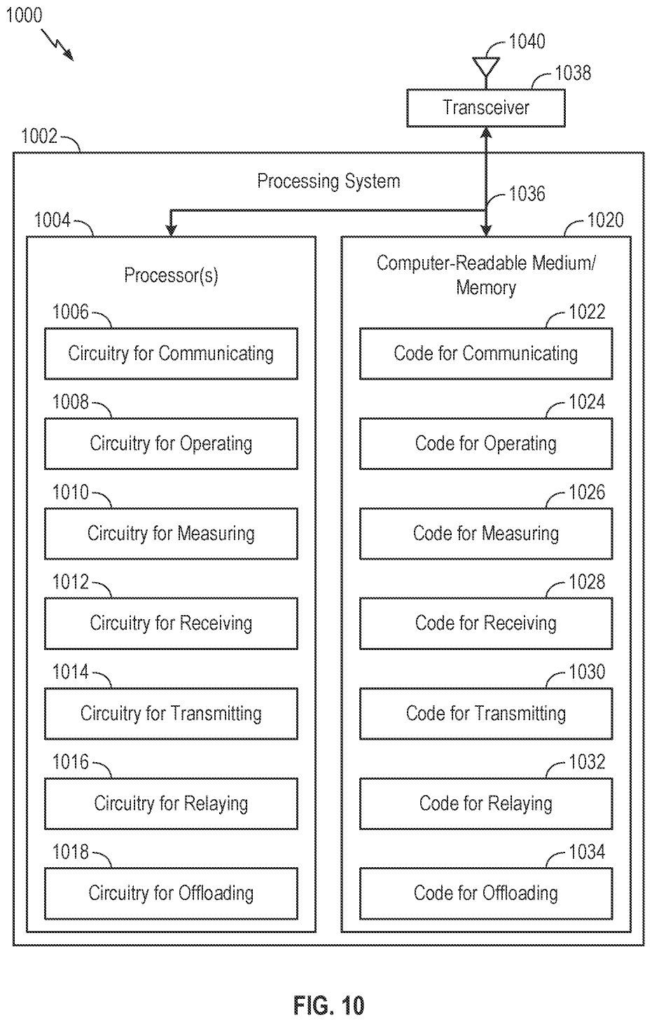

In certain aspects, method 800, or any aspect related to it, may be performed by an apparatus, such as communications device 1000 of FIG. 10, which includes various components operable, configured, or adapted to perform the method 800. Communications device 1000 is described below in further detail.

Note that FIG. 8 is just one example of a method, and other methods including fewer, additional, or alternative steps are possible consistent with this disclosure.

### Example Communications Devices

FIG. 9 depicts aspects of an example communications device 900. In some aspects, communications device 900 is a network entity, such as BS 102 of FIGS. 1 and 3, or a disaggregated base station as discussed with respect to FIG. 2.

The communications device 900 includes a processing system 905 coupled to a transceiver 985 (e.g., a transmitter and/or a receiver) and/or a network interface 995. The transceiver 985 is configured to transmit and receive signals for the communications device 900 via an antenna 990, such as the various signals as described herein. The network interface 995 is configured to obtain and send signals for the communications device 900 via communications link(s), such as a backhaul link, midhaul link, and/or fronthaul link as described herein, such as with respect to FIG. 2. The processing system 905 may be configured to perform processing functions for the communications device 900, including processing signals received and/or to be transmitted by the communications device 900.

The processing system 905 includes one or more processors 910. In various aspects, one or more processors 910 may be representative of one or more of receive processor 338, transmit processor 320, TX MIMO processor 330, and/or controller/processor 340, as described with respect to FIG. 3. The one or more processors 910 are coupled to a computer-readable medium/memory 945 via a bus 980. In certain aspects, the computer-readable medium/memory 945 is configured to store instructions (e.g., computer-executable code) that when executed by the one or more processors 910, enable and cause the one or more processors 910 to perform the method 700 described with respect to FIG. 7, or any aspect related to it, including any additional steps or sub-steps described in relation to FIG. 7. Note that reference to a processor of communications device 900 performing a function may include one or more processors of communications device 900 performing that function, such as in a distributed fashion.

In the depicted example, the computer-readable medium/memory 945 stores code for communicating 950, code for operating 955, code for measuring 960, code for transmitting 965, code for receiving 970, and code for estimating 975. Processing of the code 950-975 may enable and cause the communications device 900 to perform the method 700 described with respect to FIG. 7, or any aspect related to it.

The one or more processors 910 include circuitry configured to implement (e.g., execute) the code stored in the computer-readable medium/memory 945, including circuitry for communicating 915, circuitry for operating 920, circuitry for measuring 925, circuitry for transmitting 930, circuitry for receiving 935, and circuitry for estimating 940. Processing with circuitry 915-940 may enable and cause the communications device 900 to perform the method 700 described with respect to FIG. 7, or any aspect related to it.

More generally, means for communicating, transmitting, sending or outputting for transmission may include the transceivers 332, antenna(s) 334, transmit processor 320, TX MIMO processor 330, and/or controller/processor 340 of the BS 102 illustrated in FIG. 3, transceiver 985 and/or antenna 990 of the communications device 900 in FIG. 9, and/or one or more processors 910 of the communications device 900 in FIG. 9. Means for communicating, receiving or obtaining may include the transceivers 332, antenna(s) 334, receive processor 338, and/or controller/processor 340 of the BS 102 illustrated in FIG. 3, transceiver 985 and/or antenna 990 of the communications device 900 in FIG. 9, and/or one or more processors 910 of the communications device 900 in FIG. 9.

FIG. 10 depicts aspects of an example communications device 1000. In some aspects, communications device 1000 is a user equipment, such as UE 104 described above with respect to FIGS. 1 and 3.

The communications device 1000 includes a processing system 1002 coupled to a transceiver 1038 (e.g., a transmitter and/or a receiver). The transceiver 1038 is configured to transmit and receive signals for the communications device 1000 via an antenna 1040, such as the various signals as described herein. The processing system 1002 may be configured to perform processing functions for the communications device 1000, including processing signals received and/or to be transmitted by the communications device 1000.

The processing system 1002 includes one or more processors 1004. In various aspects, the one or more processors 1004 may be representative of one or more of receive processor 358, transmit processor 364, TX MIMO processor 366, and/or controller/processor 380, as described with respect to FIG. 3. The one or more processors 1004 are coupled to a computer-readable medium/memory 1020 via a bus 1036. In certain aspects, the computer-readable medium/memory 1020 is configured to store instructions (e.g., computer-executable code) that when executed by the one or more processors 1004, enable and cause the one or more processors 1004 to perform the method 800 described with respect to FIG. 8, or any aspect related to it, including any additional steps or sub-steps described in relation to FIG. 8. Note that reference to a processor performing a function of communications device 1000 may include one or more processors performing that function of communications device 1000, such as in a distributed fashion.

In the depicted example, computer-readable medium/memory 1020 stores code for communicating 1022, code for operating 1024, code for measuring 1026, code for receiving 1028, code for transmitting 1030, code for relaying 1032, and code for offloading 1034. Processing of the code 1022-1034 may enable and cause the communications device 1000 to perform the method 800 described with respect to FIG. 8, or any aspect related to it.

The one or more processors 1004 include circuitry configured to implement (e.g., execute) the code stored in the computer-readable medium/memory 1020, including circuitry for communicating 1006, circuitry for operating 1008, circuitry for measuring 1010, circuitry for receiving 1012, circuitry for transmitting 1014, circuitry for relaying 1016, and circuitry for offloading 1018. Processing with circuitry 1006-1018 may enable and cause the communications device 1000 to perform the method 800 described with respect to FIG. 8, or any aspect related to it.

More generally, means for communicating, transmitting, sending or outputting for transmission may include the transceivers 354, antenna(s) 352, transmit processor 364, TX MIMO processor 366, and/or controller/processor 380 of the UE 104 illustrated in FIG. 3, transceiver 1038 and/or antenna 1040 of the communications device 1000 in FIG. 10, and/or one or more processors 1004 of the communications device 1000 in FIG. 10. Means for communicating, receiving or obtaining may include the transceivers 354, antenna(s) 352, receive processor 358, and/or controller/processor 380 of the UE 104 illustrated in FIG. 3, transceiver 1038 and/or antenna 1040 of the communications device 1000 in FIG. 10, and/or one or more processors 1004 of the communications device 1000 in FIG. 10.

### Example Clauses

Implementation examples are described in the following numbered clauses:

Clause 1: A method for wireless communications by an apparatus comprising: communicating between the apparatus and at least one of a first network entity or a UE, at least one of: one or more first parameters based on measurements for a first user plane configured for exchanging information between the UE and the first network entity, wherein the first network entity is associated with a first RAN; one or more second parameters based on measurements for a second user plane configured for exchanging information between the UE and the apparatus, wherein the apparatus is associated with a second RAN; a first RRC state of the UE in the first RAN; or a second RRC state of the UE in the second RAN; and operating based on at least one of the one or more first parameters, the one or more second parameters, the first RRC state of the UE in the first RAN, or the second RRC state of the UE in the second RAN.

Clause 2: The method of Clause 1, wherein communicating comprises transmitting the one or more second parameters comprising at least one of: one or more uplink throughputs associated with one or more DRBs associated with the second user plane; one or more downlink throughputs associated with the one or more DRBs; one or more uplink packet delays associated with the one or more DRBs; one or more downlink packet delays associated with the one or more DRBs; or one or more packet loss rates associated with the one or more DRBs.

Clause 3: The method of Clause 2, further comprising: measuring at least one of: the one or more uplink throughputs; the one or more downlink throughputs; the one or more uplink packet delays; the one or more downlink packet delays; or the one or more packet loss rates.

Clause 4: The method of any one of Clauses 1-3, wherein communicating comprises transmitting the one or more second parameters comprising at least one of: one or more uplink throughput statistics for one or more uplink throughputs associated with one or more DRBs associated with the second user plane; one or more downlink throughput statistics for one or more downlink throughputs associated with the one or more DRBs; one or more uplink packet delay statistics for one or more uplink packet delays associated with the one or more DRBs; one or more downlink packet delay statistics for one or more downlink packet delays associated with the one or more DRBs; or one or more packet loss rate statistics for one or more packet loss rates associated with the one or more DRBs.

Clause 5: The method of any one of Clauses 1-4, wherein communicating comprises transmitting the one or more second parameters comprising at least one of an available uplink capacity associated with one or more DRBs associated with the second user plane or an available downlink capacity associated with the one or more DRBs associated with the second user plane.

Clause 6: The method of any one of Clauses 1-5, wherein communicating comprises transmitting, to the first network entity, at least one of the one or more second parameters or the second RRC state.

Clause 7: The method of Clause 6, wherein transmitting, to the first network entity, at least one of the one or more second parameters or the second RRC state, comprises transmitting, to the first network entity, at least one of the one or more second parameters or the second RRC state via: the UE, or a CN of the first RAN and a CN of the second RAN.

Clause 8: The method of any one of Clauses 1-7, further comprising transmitting, to the first network entity, a request for an activation or a deactivation of packet duplication over: the first user plane of packets exchanged over the second user plane; or the second user plane of packets exchanged over the first user plane.

Clause 9: The method of any one of Clauses 1-8, further comprising: transmitting, to the first network entity, a carrier aggregation configuration.

Clause 10: The method of any one of Clauses 1-9, wherein communicating at least one of the one or more first parameters, the one or more second parameters, the first RRC state, or the second RRC state, comprises receiving, from the UE or the first network entity, at least one of the one or more first parameters or the first RRC state.

Clause 11: The method of Clause 10, wherein the one or more first parameters comprise at least one of: one or more uplink throughputs associated with one or more DRBs associated with the first user plane; one or more downlink throughputs associated with the one or more DRBs; one or more uplink packet delays associated with the one or more DRBs; one or more downlink packet delays associated with the one or more DRBs; one or more a packet loss rates associated with the one or more DRBs; an available uplink capacity associated with the one or more DRBs; or an available downlink capacity associated with the one or more DRBs.

Clause 12: The method of Clause 10, wherein the one or more first parameters comprise at least one of: one or more uplink throughput statistics for one or more uplink throughputs associated with one or more DRBs associated with the first user plane; one or more downlink throughput statistics for one or more downlink throughputs associated with the one or more DRBs; one or more uplink packet delay statistics for one or more uplink packet delays associated with the one or more DRBs; one or more downlink packet delay statistics for one or more downlink packet delays associated with the one or more DRBs; or one or more packet loss rate statistics for one or more packet loss rates associated with the one or more DRBs.

Clause 13: The method of Clause 10, wherein receiving, from the first network entity, at least one of the one or more first parameters or the first RRC state, comprises receiving, from the first network entity, at least one of the one or more first parameters or the first RRC state via: the UE, or a CN of the first RAN and a CN of the second RAN.

Clause 14: The method of any one of Clauses 1-13, wherein operating based on the one or more first parameters or the first RRC state of the UE in the first RAN, comprises transmitting, to the UE, an indication to offload traffic associated with one or more DRBs associated with the second user plane to the first user plane.

Clause 15: The method of Clause 14, wherein communicating at least one of the one or more first parameters, the one or more second parameters, the first RRC state, or the second RRC state, comprises receiving, from the UE or the first network entity, the one or more first parameters; and the method further comprises: determining the one or more second parameters for the second user plane; and determining to offload the traffic based on at least one of: the one or more second parameters, the one or more first parameters, a first percentage of UE traffic configured to exchange over the first user plane; a second percentage of UE traffic configured to exchange over the second user plane; or a maximum amount of UE traffic that can be exchanged over the second user plane.

Clause 16: The method of any one of Clauses 1-15, wherein operating based on the first RRC state of the UE in the first RAN comprises transmitting, to multiple UEs including the UE, an indication to offload traffic, for the multiple UEs, associated with one or more DRBs associated with the second user plane to the first user plane.

Clause 17: The method of Clause 16, wherein communicating at least one of the one or more first parameters, the one or more second parameters, the first RRC state, or the second RRC state, comprises receiving, from the UE or the first network entity, the first RRC state; and the method further comprises: receiving an RRC state of one or more other UEs of the multiple UEs; determining a total number of the one or more other UEs and the UE is less than a threshold; and determining to offload the traffic for the multiple UEs from the second user plane to the first user plane based on the total number of the one or more other UEs and the UE being less than the threshold.

Clause 18: The method of any one of Clauses 1-17, wherein operating based on the first RRC state of the UE in the first RAN comprises: determining that the UE is unable to communicate in a serving cell of the second RAN; and transmitting, to the UE, an indication to offload traffic associated with one or more DRBs associated with the second user plane to the first user plane.

Clause 19: The method of any one of Clauses 1-18, wherein operating based on the one or more first parameters or the first RRC state of the UE in the first RAN comprises activating or deactivating packet duplication over: the second user plane of packets exchanged over the first user plane; or the first use plane of packets exchanged over the second user plane.

Clause 20: The method of any one of Clauses 1-19, further comprising: receiving, from the first network entity, a request for an activation or a deactivation of packet duplication over: the second user plane of packets exchanged over the first user plane; or the first user plane of packets exchanged over the second user plane.

Clause 21: The method of any one of Clauses 1-20, further comprising: receiving, from the first network entity, a carrier aggregation configuration; and estimating, based on the carrier aggregation configuration, at least one of: an uplink throughput statistic for the first user plane; a downlink throughput statistic for the first user plane; an achievable uplink throughput statistic for first user plane; or an achievable downlink throughput statistic for the first user plane.

Clause 22: A method for wireless communications by an apparatus comprising: communicating between the apparatus and at least one of a first network entity or a second network entity, at least one of: one or more first parameters based on measurements for a first user plane configured for exchanging information between the apparatus and the first network entity, wherein the first network entity is associated with a first RAN; one or more second parameters based on measurements for a second user plane configured for exchanging information between the apparatus and the second network entity, wherein the second network entity is associated with a second RAN; a first RRC state of the apparatus in the first RAN; or a second RRC state of the apparatus in the second RAN; and operating based on at least one of the one or more first parameters, the one or more second parameters, the first RRC state of the apparatus in the first RAN, or the second RRC state of the apparatus in the second RAN.

Clause 23: The method of Clause 22, wherein communicating comprises at least one of: transmitting the one or more first parameters to the second network entity, the one or more first parameters comprising at least one of: one or more first uplink throughputs associated with one or more first DRBs associated with the first user plane; one or more first downlink throughputs associated with the one or more first DRBs; one or more first uplink packet delays associated with the one or more first DRBs; one or more first downlink packet delays associated with the one or more first DRBs; one or more first packet loss rates associated with the one or more first DRBs; an available first uplink capacity associated with the one or more first DRBs; or an available first downlink capacity associated with the one or more first DRBs; or transmitting the one or more second parameters to the second network entity, the one or more second parameters comprising at least one of: one or more second uplink throughputs associated with one or more second DRBs associated with the second user plane; one or more second downlink throughputs associated with the one or more second DRBs; one or more second uplink packet delays associated with the one or more second DRBs; one or more second downlink packet delays associated with the one or more second DRBs; one or more second packet loss rates associated with the one or more second DRBs: an available second uplink capacity associated with the one or more second DRBs; or an available second downlink capacity associated with the one or more second DRBs.

Clause 24: The method of Clause 23, further comprising: measuring at least one of: the one or more first uplink throughputs; the one or more first downlink throughputs: the one or more first uplink packet delays; the one or more first downlink packet delays: the one or more first packet loss rates; the one or more second uplink throughputs; the one or more second downlink throughputs; the one or more second uplink packet delays; the one or more second downlink packet delays; or the one or more second packet loss rates.

Clause 25: The method of Clause 23, further comprising at least one of: receiving, from the first network entity, at least one of: the one or more first uplink throughputs; the one or more first downlink throughputs; the one or more first uplink packet delays: the one or more first downlink packet delays; the one or more first packet loss rates; the available first uplink capacity: or the available first downlink capacity; or receiving, from the second network entity, at least one of: the one or more second uplink throughputs; the one or more second downlink throughputs; the one or more second uplink packet delays: the one or more second downlink packet delays; the one or more second packet loss rates; the available second uplink capacity: or the available second downlink capacity.

Clause 26: The method of any one of Clauses 22-25, wherein communicating comprises at least one of: transmitting the one or more first parameters to the second network entity, the one or more first parameters comprising at least one of: one or more first uplink throughput statistics for one or more first uplink throughputs associated with one or more first DRBs associated with the first user plane; one or more first downlink throughput statistics for one or more first downlink throughputs associated with the one or more first DRBs; one or more first uplink packet delay statistics for one or more first uplink packet delays associated with the one or more first DRBs; one or more first downlink packet delay statistics for one or more first downlink packet delays associated with the one or more first DRBs; or one or more first packet loss rate statistics for one or more first packet loss rates associated with the one or more first DRBs; or transmitting the one or more second parameters to the first network entity, the one or more second parameters comprising at least one of: one or more second uplink throughput statistics for one or more second uplink throughputs associated with one or more second DRBs associated with the second user plane; one or more second downlink throughput statistics for one or more second downlink throughputs associated with the one or more second DRBs; one or more second uplink packet delay statistics for one or more second uplink packet delays associated with the one or more second DRBs; one or more second downlink packet delay statistics for one or more second downlink packet delays associated with the one or more second DRBs; or one or more second packet loss rate statistics for one or more second packet loss rates associated with the one or more second DRBs.

Clause 27: The method of Clause 26, further comprising at least one of: receiving, from the first network entity, at least one of: the one or more first uplink throughput statistics; the one or more first downlink throughput statistics; the one or more first uplink packet delay statistics; the one or more first downlink packet delay statistics; or the one or more first packet loss rate statistics; or receiving, from the second network entity, at least one of: the one or more second uplink throughput statistics; the one or more second downlink throughput statistics; the one or more second uplink packet delay statistics; the one or more second downlink packet delay statistics; or the one or more second packet loss rate statistics.

Clause 28: The method of any one of Clauses 22-27, wherein communicating comprises at least one of: transmitting the first RRC state to the second network entity; or transmitting the second RRC state to the first network entity.

Clause 29: The method of Clause 28, wherein communicating comprises at least one of: receiving the first RRC state to the first network entity; or receiving the second RRC state to the second network entity.

Clause 30: The method of any one of Clauses 22-29, further comprising at least one of: transmitting, to the first network entity, a first carrier aggregation configuration of the apparatus in the first RAN; or transmitting, to the second network entity, a second carrier aggregation configuration of the apparatus in the second RAN.

Clause 31: The method of any one of Clauses 22-30, further comprising: relaying, between the first network entity and the second network entity, a request for an activation or a deactivation of packet duplication over: the first user plane of packets exchanged over the second user plane; or the second user plane of packets exchanged over the first user plane.

Clause 32: The method of any one of Clauses 22-31, further comprising: relaying, between the first network entity and the second network entity, an indication to: offload traffic associated with one or more first DRBs associated with the first user plane to the second user plane; or offload traffic associated with one or more second DRBs associated with the second user plane to the first user plane.

Clause 33: The method of any one of Clauses 22-32, further comprising: offloading traffic associated with one or more first DRBs associated with the first user plane to the second user plane; and offloading traffic associated with one or more second DRBs associated with the second user plane to the first user plane.

Clause 34: One or more apparatuses, comprising: one or more memories comprising executable instructions; and one or more processors configured to execute the executable instructions and cause the one or more apparatuses to perform a method in accordance with any one of clauses 1-33.

Clause 35: One or more apparatuses, comprising means for performing a method in accordance with any one of clauses 1-33.

Clause 36: One or more non-transitory computer-readable media comprising executable instructions that, when executed by one or more processors of one or more apparatuses, cause the one or more apparatuses to perform a method in accordance with any one of clauses 1-33.

Clause 37: One or more computer program products embodied on one or more computer-readable storage media comprising code for performing a method in accordance with any one of clauses 1-33.

Clause 38: One or more apparatuses, comprising: one or more memories; and one or more processors, coupled to the one or more memories, configured to cause the one or more apparatuses to perform a method in accordance with any one of clauses 1-33.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “a controller,” “a memory,” “a transceiver,” “an antenna,” “the processor,” “the controller,” “the memory,” “the transceiver,” “the antenna,” etc.), unless otherwise specifically stated, should be understood to refer to one or more elements (e.g., “one or more processors,” “one or more controllers,” “one or more memories,” “one more transceivers,” etc.). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus configured for wireless communications, comprising:
one or more memories; and
one or more processors, coupled to the one or more memories, configured to cause the apparatus to:
communicate between the apparatus and at least one of a first network entity or a user equipment (UE), at least one of:
one or more first parameters based on measurements for a first user plane configured for exchanging information between the UE and the first network entity, wherein the first network entity is associated with a first radio access network (RAN);
one or more second parameters based on measurements for a second user plane configured for exchanging information between the UE and the apparatus, wherein the apparatus is associated with a second RAN;
a first radio resource control (RRC) state of the UE in the first RAN: or
a second RRC state of the UE in the second RAN; and
operate based on at least one of the one or more first parameters, the one or more second parameters, the first RRC state of the UE in the first RAN, or the second RRC state of the UE in the second RAN.

2. The apparatus of claim 1, wherein to communicate, the one or more processors are configured to cause the apparatus to transmit the one or more second parameters comprising at least one of:
one or more uplink throughputs associated with one or more data radio bearers (DRBs) associated with the second user plane;
one or more downlink throughputs associated with the one or more DRBs;
one or more uplink packet delays associated with the one or more DRBs;
one or more downlink packet delays associated with the one or more DRBs; or
one or more packet loss rates associated with the one or more DRBs.

3. The apparatus of claim 2, wherein the one or more processors are configured to cause the apparatus to measure at least one of:
the one or more uplink throughputs;
the one or more downlink throughputs;
the one or more uplink packet delays;
the one or more downlink packet delays; or
the one or more packet loss rates.

4. The apparatus of claim 1, wherein to communicate, the one or more processors are configured to cause the apparatus to transmit the one or more second parameters comprising at least one of:
one or more uplink throughput statistics for one or more uplink throughputs associated with one or more data radio bearers (DRBs) associated with the second user plane;
one or more downlink throughput statistics for one or more downlink throughputs associated with the one or more DRBs;
one or more uplink packet delay statistics for one or more uplink packet delays associated with the one or more DRBs;
one or more downlink packet delay statistics for one or more downlink packet delays associated with the one or more DRBs; or
one or more packet loss rate statistics for one or more packet loss rates associated with the one or more DRBs.

5. The apparatus of claim 1, wherein to communicate, the one or more processors are configured to cause the apparatus to transmit the one or more second parameters comprising at least one of an available uplink capacity associated with one or more data radio bearers (DRBs) associated with the second user plane or an available downlink capacity associated with the one or more DRBs associated with the second user plane.

6. The apparatus of claim 1, wherein to communicate, the one or more processors are configured to cause the apparatus to transmit, to the first network entity, at least one of the one or more second parameters or the second RRC state via:
the UE, or
a core network (CN) of the first RAN and a CN of the second RAN.

7. The apparatus of claim 1, wherein the one or more processors are configured to cause the apparatus to transmit, to the first network entity, a request for an activation or a deactivation of packet duplication over:
the first user plane of packets exchanged over the second user plane; or
the second user plane of packets exchanged over the first user plane.

8. The apparatus of claim 1, wherein the one or more processors are configured to cause the apparatus to transmit, to the first network entity, a carrier aggregation configuration.

9. The apparatus of claim 1, wherein to communicate at least one of the one or more first parameters, the one or more second parameters, the first RRC state, or the second RRC state, the one or more processors are configured to cause the apparatus to receive, from the UE or the first network entity, at least one of the one or more first parameters or the first RRC state via:
the UE, or
a core network (CN) of the first RAN and a CN of the second RAN.

10. The apparatus of claim 9, wherein the one or more first parameters comprise at least one of:
one or more uplink throughputs associated with one or more data radio bearers (DRBs) associated with the first user plane;
one or more downlink throughputs associated with the one or more DRBs;
one or more uplink packet delays associated with the one or more DRBs;
one or more downlink packet delays associated with the one or more DRBs;
one or more a packet loss rates associated with the one or more DRBs;
an available uplink capacity associated with the one or more DRBs; or
an available downlink capacity associated with the one or more DRBs.

11. The apparatus of claim 1, wherein to operate based on the one or more first parameters or the first RRC state of the UE in the first RAN, the one or more processors are configured to cause the apparatus to:
transmit, to the UE, an indication to offload traffic associated with one or more data radio bearers (DRBs) associated with the second user plane to the first user plane.

12. The apparatus of claim 11, wherein:
to communicate at least one of the one or more first parameters, the one or more second parameters, the first RRC state, or the second RRC state, the one or more processors are configured to cause the apparatus to receive, from the UE or the first network entity, the one or more first parameters; and
the one or more processors are configured to cause the apparatus to:
determine the one or more second parameters for the second user plane; and
determine to offload the traffic based on at least one of:
the one or more second parameters,
the one or more first parameters,
a first percentage of UE traffic configured to exchange over the first user plane:
a second percentage of UE traffic configured to exchange over the second user plane; or
a maximum amount of UE traffic that can be exchanged over the second user plane.

13. The apparatus of claim 1, wherein to operate based on the first RRC state of the UE in the first RAN, the one or more processors are configured to cause the apparatus to:
transmit, to multiple UEs including the UE, an indication to offload traffic, for the multiple UEs, associated with one or more data radio bearers (DRBs) associated with the second user plane to the first user plane.

14. The apparatus of claim 1, wherein to operate based on the first RRC state of the UE in the first RAN, the one or more processors are configured to cause the apparatus to:
determine that the UE is unable to communicate in a serving cell of the second RAN; and
transmit, to the UE, an indication to offload traffic associated with one or more data radio bearers (DRBs) associated with the second user plane to the first user plane.

15. The apparatus of claim 1, wherein to operate based on the one or more first parameters or the first RRC state of the UE in the first RAN, the one or more processors are configured to cause the apparatus to activate or deactivate packet duplication over:
the second user plane of packets exchanged over the first user plane; or
the first use plane of packets exchanged over the second user plane.

16. The apparatus of claim 1, wherein the one or more processors are configured to cause the apparatus to receive, from the first network entity, a request for an activation or a deactivation of packet duplication over:
the second user plane of packets exchanged over the first user plane; or
the first user plane of packets exchanged over the second user plane.

17. The apparatus of claim 1, wherein the one or more processors are configured to cause the apparatus to:
receive, from the first network entity, a carrier aggregation configuration; and
based on the carrier aggregation configuration, estimate at least one of:
an uplink throughput statistic for the first user plane;
a downlink throughput statistic for the first user plane;
an achievable uplink throughput statistic for first user plane; or
an achievable downlink throughput statistic for the first user plane.

18. An apparatus configured for wireless communications, comprising:
one or more memories; and
one or more processors, coupled to the one or more memories, configured to cause the apparatus to:
communicate between the apparatus and at least one of a first network entity or a second network entity, at least one of:
one or more first parameters based on measurements for a first user plane configured for exchanging information between the apparatus and the first network entity, wherein the first network entity is associated with a first radio access network (RAN);
one or more second parameters based on measurements for a second user plane configured for exchanging information between the apparatus and the second network entity, wherein the second network entity is associated with a second RAN;
a first radio resource control (RRC) state of the apparatus in the first RAN; or
a second RRC state of the apparatus in the second RAN; and
operate based on at least one of the one or more first parameters, the one or more second parameters, the first RRC state of the apparatus in the first RAN, or the second RRC state of the apparatus in the second RAN.

19. The apparatus of claim 18, wherein to communicate, the one or more processors are configured to cause the apparatus to, at least one of:
transmit the one or more first parameters to the second network entity, the one or more first parameters comprising at least one of:
one or more first uplink throughputs associated with one or more first data radio bearers (DRBs) associated with the first user plane;
one or more first downlink throughputs associated with the one or more first DRBs;
one or more first uplink packet delays associated with the one or more first DRBs;
one or more first downlink packet delays associated with the one or more first DRBs;
one or more first packet loss rates associated with the one or more first DRBs;
an available first uplink capacity associated with the one or more first DRBs; or
an available first downlink capacity associated with the one or more first DRBs; or
transmit the one or more second parameters to the first network entity, the one or more second parameters comprising at least one of:
one or more second uplink throughputs associated with one or more second DRBs associated with the second user plane;
one or more second downlink throughputs associated with the one or more second DRBs;
one or more second uplink packet delays associated with the one or more second DRBs;
one or more second downlink packet delays associated with the one or more second DRBs;
one or more second packet loss rates associated with the one or more second DRBs;
an available second uplink capacity associated with the one or more second DRBs; or
an available second downlink capacity associated with the one or more second DRBs.

20. A method for wireless communications by an apparatus, comprising:
communicating between the apparatus and at least one of a first network entity or a user equipment (UE), at least one of:
one or more first parameters based on measurements for a first user plane configured for exchanging information between the UE and the first network entity, wherein the first network entity is associated with a first radio access network (RAN);
one or more second parameters based on measurements for a second user plane configured for exchanging information between the UE and the apparatus, wherein the apparatus is associated with a second RAN;
a first radio resource control (RRC) state of the UE in the first RAN; or
a second RRC state of the UE in the second RAN; and
operating based on at least one of the one or more first parameters, the one or more second parameters, the first RRC state of the UE in the first RAN, or the second RRC state of the UE in the second RAN.
